(19) United States
(12) Patent Application Publication
(10) Pub. No.: US 2026/0272764 A1
(43) Pub. Date: Sep. 17, 2026

(54) COMBINED MASSAGE STRUCTURE AND SUSPENDED TRIBOELECTRIC NANOGENERATING MASSAGE BEAD

(71) Applicant: Haibin WANG, Shanghai (CN)

(72) Inventor: Haibin WANG, Shanghai (CN)

(21) Appl. No.: 19/665,462

(22) Filed: May 1, 2026

Related U.S. Application Data
(63) Continuation-in-part of application No. 18/307,616, filed on Apr. 26, 2023, now Pat. No. 12,642,737.
Application No. 18/307,616 is a division of application No. PCT/CN2021/141305, filed on Dec. 24, 2021.

(30) Foreign Application Priority Data
Dec. 25, 2020 (CN) 202011561330.X
Dec. 25, 2020 (CN) 202023177997.8
Dec. 22, 2021 (CN) 202111580367.1
Dec. 22, 2021 (CN) 202123246461.1
Sep. 20, 2023 (CN) 202311213577.6

(51) Int. Cl. A61H 15/00

(52) U.S. Cl. CPC A61H 15/00; A61H 2201/165; A61H 2205/12

(57) ABSTRACT

The present invention relates to a combined massage structure comprising massage beads, spring body insulating holders and massage hole seats, wherein each of the massage beads includes a massage structure, a connecting member and a spring body, the massage hole seats are disposed on an massage base plate, the spring body insulating holders are arranged inside the massage hole seats, a twisting spring at one end of the spring body is snap fitted in the spring body insulating holder, and the other end thereof is connected with a straight spring arm cavity formed on the connecting member with a clearance therebetween, the massage structure is fixedly connected to an end of the connecting member opposite to the spring body, and the massage beads protrude above the massage base plate. The present invention also relates to a suspended triboelectric nanogenerating massage bead.

### CROSS REFERENCE TO THE RELATED APPLICATIONS

The present application is a continuation-in-part of U.S. patent application Ser. No. 18/307,616 entitled “MASSAGE BEAD, A PAIR OF SHOES AND CUSHION”, the entire contents of which are hereby incorporated by reference.

### TECHNICAL FIELD

The present invention belongs to the technical field of massage, and in particular, relates to a combined massage structure and a suspended triboelectric nanogenerating massage bead.

### DESCRIPTION OF THE PRIOR ART

With the continuous development and progress of the economy, living standards are getting higher and higher, and correspondingly, the pursuit of health is becoming more and more intense. As a small massage device, especially a massage device that can be packed into insoles and base plates, it can satisfy people's needs for massaging while walking to a large extent.

Similar massage devices, such as more forms of massage shoes, have occurred at present. For example, the utility model CN200520026389.3 discloses a pair of slippers for massaging foot soles. The massage mechanism in the slippers adopts a foot sole massaging column, the foot sole massaging column is mounted on a spring, and the massage effect is realized by pressing the spring. However, this massaging method can only achieve vertical pressing relative to the sole, and cannot rotate at a large angle on the plane of the sole.

The utility model CN201220446441.0 discloses a rotary massage slipper, wherein helical grooves are formed on the side surface of each base, limiting projections are formed on the outer side surface of each massage key body, and the projections snap into the grooves, so that the massage key body can rotationally move up and down along the grooves. Similarly, for example, the CLORIS™ massage slipper currently on the market has a sole provided with rotatable massage buttons; wherein for the main structure of the massage buttons, refer to the schematic diagram shown in FIG. 1. Under the action of pressing down on the foot sole, through the cooperation of the projection 12 on the button 11 and the inclined sliding groove 14 embedded on the button sleeve 13 outside the button, the projection 12 slides obliquely in the sliding groove when the button 11 moves downward, so that the upper end face of the button further realizes the rotation on the horizontal plane while the button moving downward. However, in this type of massage device that realizes rotation through the sliding groove, limited by the diameter of the button or massage body (set on the sole and the size cannot be too large), the angle of the sliding groove is limited, resulting in only a small angle of rotation on the horizontal plane, which can only be rotated about 10 degrees. The rotation angle is the ratio of the projection of the sliding groove on the bottom plane to the entire bottom plane. If the angle of the sliding groove is too large, problems such as stagnation and poor structural stability may be caused. Further, limited by height, the length of the sliding groove is also limited. Due to the small rotation angle, the functionality is relatively poor. Due to the sliding structure, the frictional force is relatively large, and long-term use is easy to wear the projections and inclined grooves, resulting in degradation or failure of the rotation function.

Against the backdrop of upgrading health consumption and increasingly refined demands for foot care, footwear and insole products with foot massage functions have gradually evolved from daily necessities with single function into health care equipment. As an important reflex zone of human meridians and the “second heart” of the human body, the foot sole is closely associated with the overall physical functions of the human body. Long-term and moderate foot sole stimulation delivers health benefits such as promoting qi and blood circulation and relieving muscle tension. Based on this understanding, mechanical and electronic massage insoles have become mainstream products in the market. However, the prior art still has significant limitations in terms of functional adaptability, usage flexibility and wearing comfort, specifically:

Most existing massage products adopt a fixed structural design, making it difficult to meet the personalized needs of different users and adapt to dynamic usage scenarios. Mechanical massage insoles mainly achieve massage stimulation effect through fixed protruded particles, wave-shaped textures and other surface structures via natural pressing during walking. Nevertheless, the height, density and distribution of such protrusions are preset, and cannot be adjusted according to differences in users' foot shapes (such as arch height and forefoot width) and pain tolerance levels (such as sensitive population and ordinary population). Although some products attempt to adjust thickness through stacked layers, such designs only change the overall massage intensity, and fail to realize precise stimulation and control for specific foot sole acupoints (such as Yongquan acupoint and Taichong acupoint).

While electronic massage insoles support selection of multiple massage modes, they rely on an external power supply. The integration of electronic components also results in bulky products and reduced air permeability, making them incompatible with various shoe types such as sneakers and leather shoes, and restricting their popularization and application in daily commuting, sports and other scenarios.

As mentioned above, the existing massage structures feature single functions and poor adjustability, cannot adapt to diverse product forms, and fail to fully meet user demands. Therefore, there is an urgent need to develop a combined massage structure and massage shoes that can be configured according to actual usage requirements.

### SUMMARY OF THE INVENTION

To solve the technical problems existing in the background art, the first aspect of the present invention provides a combined massage structure comprising massage beads, spring body insulating holders and massage hole seats, wherein each of the massage beads includes a massage structure, a connecting member and a spring body, the massage hole seats are disposed on an massage base plate, the spring body insulating holders are arranged inside the massage hole seats, a twisting spring at one end of the spring body is snap fitted in the spring body insulating holder, and the other end thereof is connected with a straight spring arm cavity formed on the connecting member with a clearance therebetween, the massage structure is fixedly connected to an end of the connecting member opposite to the spring body, and the massage beads protrude above the massage base plate.

According to the first aspect of the present invention, the spring body includes a pair of upper straight spring arms, one end of the pair of upper straight spring arms is suspended, and the other end thereof is bent and extended downward through a pair of curved spring arms to connect with a pair of twisting springs, and an extension arm is formed between the twisting springs.

According to the first aspect of the present invention, the top-view outline of the extension arm is Z-shaped or “-” shaped, and the extension arm is fixedly connected, the connection mode and connection structure thereof are not limited by the bottom outline shape of the extension arm.

According to the first aspect of the present invention, the spring body with Z-shaped extension arm and the spring body with “-” shaped extension arm are disposed to overlap individually or in combination at an angle, preferably perpendicularly, the spring body with Z-shaped extension arm and the spring body with “-” shaped extension arm are individually formed or integrally formed, or the Z-shaped and “-” shaped extension arms of the spring body are connected together by welding.

According to the first aspect of the present invention, the connecting member and the massage structure are arranged in one-to-one correspondence, the surface of the massage structure can be adapted to more than one massage contact point, the connecting member is provided with one pair, two pairs, single or double straight spring arm cavities, the straight spring arm cavities are configured to accommodate the straight spring arms of the spring body, the straight spring arms fit with the straight spring arm cavities with a clearance therebetween, and the straight spring arms can rotate circumferentially relative to the straight spring arm cavities, the straight spring arm cavities can also be inclined to fit the straight spring arms.

According to the first aspect of the present invention, the one pair or two pairs of straight spring arm cavities are configured to accommodate clockwise straight spring arms or counterclockwise straight spring arms respectively, the connecting member is provided with a plurality of limiting blocks extending downward, the limiting blocks are configured to limit the curved spring arms to ensure that the curved spring arms perform rotational movement within a limited area during the pressing down of the massage structure and the twisting of the spring body, an extension spring is disposed on the curved spring arms to increase the rotation span, and the extension springs are not limited by the outline shape.

According to the first aspect of the present invention, the connecting member is further provided with a plurality of ramps at positions adjacent to the limiting blocks, the ramps are configured to push the curved spring arms outward to prevent wear between the curved spring arms and the twisting springs, the connecting member cooperates with the massage structure to enclose the straight spring arms, the curved spring arms and the twisting springs in a space defined by the connecting member or the massage structure and the massage hole seats.

According to the first aspect of the present invention, the spring body insulating holder is provided with a notch on one side, the notch can temporarily reduce the diameter of the spring body insulating holder for facilitating to arrange inside the massage hole seat, the shape of the interface portion between the spring body insulating holder and the inner side of the massage hole seat may be regular shapes such as circle and square, or mutually mated concave-convex engagement structures, or a combination of regular shapes and concave-convex structures, the outer contour shape of the massage hole seat is circular, hexagonal, or a mixed shape of arcs and polygons, and the overall massage hole seat adopts a combined structure of cylinder, polygonal cylinder, or mixed cylinder with arcs and polygons.

According to the first aspect of the present invention, the spring body insulating holder is made of insulating materials such as PEEK and POM, the massage hole seats are assembled and fixed on the base plate by means of gluing, tenon-and-mortise connection or other methods in a corresponding arrangement and combination manner, or the massage hole seats are integrally formed with the base plate, the massage hole seats and the matched massage beads can be tilted arbitrarily as a whole to adapt to the curved surface of the foot sole, and the thicknesses of the massage hole seats and the base plate can be adjusted as required.

The second aspect of the present invention provides a suspended triboelectric nanogenerating massage bead comprising a combined massage structure, a triboelectric nanogeneration assembly, a rectification energy storage assembly, current-limiting resistors and working electrodes, wherein the combined massage structure includes massage bead, spring body insulating holder and massage hole seat, the massage bead comprises a massage structure, a connecting member and a spring body, a twisting spring at one end of the spring body is snap fitted in the spring body insulating holder, and straight spring arm at the other end thereof is connected with straight spring arm cavity on the connecting member with a clearance therebetween, the massage structure is fixedly connected to one end of the connecting member opposite to the spring body, when the external pressure is applied to the massage structure and a dynamic balance between the external pressure and the elastic force of the spring body is reached, suspended massage can be realized, the triboelectric nanogeneration assembly includes an independent friction medium layers and back electrodes, the independent friction medium layers form a friction pair composed of a nylon film and an FEP Teflon film, the nylon film is fixed inside the massage bead and connected to the connecting member, and the FEP Teflon film is disposed opposite to the nylon film, the back electrodes include a nylon film back electrode and an FEP Teflon film back electrode, which are respectively arranged on the sides of the two films away from the friction pair, the rectification energy storage assembly includes a full-bridge rectifier module and an energy storage capacitor, the input terminal of the full-bridge rectifier module is electrically connected to the back electrodes, and the positive and negative poles of DC output terminal of the full-bridge rectifier module are electrically connected in parallel with the positive and negative poles of the energy storage capacitor, the positive and negative poles of the energy storage capacitor are electrically connected in one-to-one correspondence with the positive and negative poles of the working electrodes through the current-limiting resistors, and the working electrodes are arranged on the top surface of the massage structure, when the external pressure on the massage structure and the elastic force of the spring body alternate between the dynamic balance condition and dynamic imbalance condition and a triboelectric nanogeneration state is established, suspended friction electric pulse stimulation massage is realized.

According to the second aspect of the present invention, the suspended triboelectric nanogenerating massage bead comprises independent triboelectric nanogeneration units, namely independent TENG units, the independent TENG unit comprises a first friction layer and a corresponding first back electrode, as well as a second friction layer and a corresponding second back electrode, both the first friction layer and the second friction layer are made of insulating friction medium materials, which are prepared from any one or more of PTFE, PVDF, PDMS, PET, PI and nylon, the first back electrode and the second back electrode are adapted to flexible conductive electrodes, the first back electrode is attached to the back side of the first friction layer, and the second back electrode is attached to the back side of the second friction layer, the first friction layer and the second friction layer are arranged opposite to each other at intervals to form a friction power generation pair, and their arrangement positions are mutually interchangeable.

According to the second aspect of the present invention, the full-bridge rectifier module is provided with two AC input terminals, one DC positive output terminal and one DC negative output terminal, the two AC input terminals of the full-bridge rectifier module are electrically connected to the first back electrode and the second back electrode respectively, the DC positive output terminal and the DC negative output terminal of the full-bridge rectifier module are electrically connected to the positive pole and the negative pole of the energy storage capacitor in one-to-one correspondence, the full-bridge rectifier module is configured to rectify the output alternating current into unidirectional microampere-level weak direct current, the energy storage capacitor is configured to store the rectified pulsating DC electric energy, smooth, stabilize and filter the electric energy, and cooperate with the current-limiting resistor to continuously output stable and mild microampere-level electric pulse direct current to the working electrodes, and is connected in parallel between the two DC output terminals of the full-bridge rectifier module, a plurality of the rectification energy storage assemblies can be electrically connected in series, in parallel or in a series-parallel hybrid manner to meet different output requirements of voltage or current.

According to the second aspect of the present invention, the independent TENG unit includes a first friction layer and a second friction layer, both the first friction layer and the second friction layer are insulating polymer films with triboelectric characteristics, and are correspondingly provided with a first back electrode and a second back electrode respectively, the first back electrode and the second back electrode are flexible conductive electrodes, the triboelectric nanogeneration assembly further comprises current-limiting resistors, the current-limiting resistors can be arranged between the DC positive output terminal of the full-bridge rectifier module and an external load in a series, parallel or series-parallel hybrid connection manner, the independent TENG unit is characterized in that, on the opposite contact surfaces of the first friction layer and the second friction layer, at least one surface is provided with protruded structures or wave structures, regular or irregular hybrid protruded structures, the first friction layer adopts a nylon film and the second friction layer adopts an FEP film; or the first friction layer adopts a PTFE film and the second friction layer adopts an aluminum foil or a copper foil, and the two groups of materials are paired respectively to form the friction power generation pair.

According to the second aspect of the present invention, the working electrodes include positive acupoint electrode contacts and negative acupoint electrode contacts, one end of each positive acupoint electrode contact is connected to the positive pole of the energy storage capacitor, and the other end thereof is connected with flexible wires which pass through inner openings of the connecting member and the massage structure or extend to the top surface of the massage structure via grooves formed on the arc surface of the massage structure, to contact with the skin of the human foot sole, one end of each negative acupoint electrode contact is connected to the negative pole of the energy storage capacitor, and the other end thereof is connected with flexible wires which pass through inner openings of the connecting member and the massage structure or extend to the top surface of the massage structure via grooves formed on the arc surface of the massage structure, to contact with the skin of the human foot sole, the first friction layer descends under external pressing force and rotates under the action of the curved spring arms to contact with the second friction layer to generate triboelectrification, and static charges accumulate on the friction interface, after the external force is removed, the first friction layer is automatically reset under the action of the curved spring arms and the twisting springs, separated from the second friction layer to form a potential difference, thereby generating an electrostatic induction effect, under repeated external force, the first friction layer continuously descends, rotates and contacts the second friction layer, then separates from the second friction layer and resets, and static charges accumulate on the friction interface continuously, the separation process continuously triggers electrostatic induction, so that the first back electrode and the second back electrode periodically induce alternating charges to output alternating current, the alternating current is sent to the full-bridge rectifier module and converted into microampere-level weak direct current electric energy after rectification, the microampere-level weak DC electric energy sequentially passes through the positive pole of the energy storage capacitor and the current-limiting resistor, passes through the connecting member and the massage structure along the flexible wire, and is transmitted to the positive acupoint electrode contacts on the top surface of the massage structure, to realize microampere-level weak electrical pulse stimulation on the foot sole, the microampere-level weak direct current electric energy is further conducted to the negative acupoint electrode contacts on the top surface of the massage structure through the skin of the foot sole of human, and flows back to the negative pole of the energy storage capacitor through the flexible wires to form a complete current loop, the space between the positive and negative acupoint electrode contacts are matched with the massage structure, the triboelectric nanogeneration assembly and the current-limiting resistors, both the positive acupoint electrode contacts and the negative acupoint electrode contacts are made of flexible conductive biocompatible electrode materials, which are selected from any one of conductive silica gel, conductive silver paste, flexible conductive fabrics and silver-plated copper conductive films.

According to the second aspect of the present invention, the rectifier bridge energy storage assembly and current-limiting resistor are integrated on a small scale flexible printed circuit board, which is fixedly and insulatively mounted at connecting line position of twisting extension arm, so as not to interfere with the downward pressing and rotational movement stroke of the massage bead, all exposed points of electrical connections are insulated by encapsulation.

According to the second aspect of the present invention, parts of the electrical connections adopt flexible conductive conductors to achieve electrical connection; the points of the electrical connection are fixedly connected by plugging or welding and undergo insulated sealing treatment, all exposed conductive parts and live structures are insulated and covered with PI/PET insulating films to form an overall fully insulated protective structure, said rectifier energy storage assembly and the corresponding current-limiting resistor can adopt a flexible encapsulation structure, the outer surface of the flexible encapsulation structure is encapsulated by PI/PET insulating films and reinforced at the edges thereof.

According to the second aspect of the present invention, the independent TENG unit includes at least one set of friction medium layer units, multiple sets of friction medium layer units may be electrically connected in series, in parallel, or in a series-parallel hybrid manner, the distance between the first friction layer and the second friction layer ranges from 0.01 mm to 50 mm.

The third aspect of the present invention provides a massage base plate for a massage shoe, characterized in that the massage base plate is a base component for bearing a massage assembly in the massage shoe, the massage base plate is provided with a special-shaped structure adapted to the physiological curved contour of a human foot, and protrusions are arranged at the position corresponding to the arch of the human foot, the bottom surface of the massage base plate can be configured as a smooth surface or a rough surface, or provided with a plurality of holes and/or grooves, the shape, quantity and arrangement mode of the holes and/or grooves can be set in any combined manner to mount massage hole seats of different specifications and shapes.

### BRIEF DESCRIPTION OF THE DRAWINGS

FIG. 1 is a structural diagram of a massage button in the prior art;

FIG. 2 is a diagram of a massage bead rotating in the clockwise direction according to Embodiment 1 of the invention;

FIG. 3 is a diagram showing that the massage bead rotating in the clockwise direction shown in FIG. 2 is arranged on a base;

FIG. 4 is a diagram of a massage bead rotating in the counterclockwise direction according to Embodiment 1 of the invention;

FIG. 5 is a diagram showing that the massage bead rotating in the counterclockwise direction shown in FIG. 4 is arranged on a base;

FIG. 6 is a diagram showing three structures of an ETSA arranged in the clockwise direction according to Embodiment 1 of the invention;

FIG. 7 is a diagram showing three structures of the ETSA arranged in the counterclockwise direction according to Embodiment 1 of the invention;

FIG. 8 is a diagram showing that a first axis passes through a centerline of an extension spring body according to Embodiment 1 of the invention;

FIG. 9 is a diagram showing that the extension spring body is located at an inner side of the first axis according to Embodiment 1 of the invention;

FIG. 10 is a diagram showing that the extension spring body is located at an outer side of the first axis according to Embodiment 1 of the invention;

FIG. 11 is a diagram showing a situation after the massage body is pressed completely according to Embodiment 1 of the invention;

FIG. 12 is a three dimensional diagram of a massage base of the massage bead according to a preferred embodiment of Embodiment 1 of the invention;

FIG. 13 is a side diagram of a massage structure of the massage bead according to a preferred embodiment of Embodiment 1 of the invention;

FIG. 14 is a cross-sectional diagram of the massage base of the massage bead according to a preferred embodiment of Embodiment 1 of the invention;

FIG. 15 is a top diagram of the massage structure of the massage bead according to another preferred embodiment of Embodiment 1 of the invention;

FIG. 16 is a side diagram of the massage base of the massage bead according to another preferred embodiment of Embodiment 1 of the invention;

FIG. 17 is a diagram of a massage bead rotating in the clockwise direction according to Embodiment 2 of the invention;

FIG. 18 is a diagram of a massage bead rotating in the counterclockwise direction according to Embodiment 2 of the invention;

FIG. 19 is a three dimensional diagram of a massage base of the massage bead according to a preferred embodiment of Embodiment 3 of the invention;

FIG. 20 is a diagram of the massage bead according to Embodiment 3 of the invention;

FIG. 21 is a three dimensional diagram of a massage base of the massage bead according to a preferred embodiment of Embodiment 4 of the invention;

FIG. 22 is a diagram of the massage bead according to Embodiment 4 of the invention;

FIG. 23 is a top diagram of a sole according to Embodiment 5 of the invention;

FIG. 24 is a side diagram of a sole according to Embodiment 5 of the invention;

FIG. 25 is a side diagram of a sole attached with an insole according to another preferred embodiment of Embodiment 5 of the invention;

FIG. 26 is a schematic diagram of the massage base plate according to the supplementary solution of the present continuation application;

FIG. 27 is a schematic diagram of a sole installed with massage beads according to the supplementary solution of the present continuation application;

FIG. 28-1 is a front view and a top view of a Z-shaped spring according to the supplementary solution of the present continuation application;

FIG. 28-2 is a front view and a top view of an “-” shaped spring according to the supplementary solution of the present continuation application;

FIG. 28-3 is a top view of a combined structure of an “-” shaped spring and a Z-shaped spring according to the supplementary solution of the present continuation application;

FIG. 29 is a schematic diagram of a connecting member according to the supplementary solution of the present continuation application, showing partial structural details of the connecting member;

FIG. 30 illustrates a spring body insulating holder arranged in the connecting member in FIG. 29 according to the supplementary solution of the present continuation application;

FIG. 31 shows two embodiments of a massage sole template according to the supplementary solution of the present continuation application;

FIG. 32 shows three embodiments of a massage hole seat according to the supplementary solution of the present continuation application;

FIG. 33 illustrates a combination of hexagonal massage hole seat columns of the first embodiment in FIG. 32 according to the supplementary solution of the present continuation application;

FIG. 34 illustrates a combination of mixed-polygon massage hole seat columns of the second embodiment in FIG. 32 according to the supplementary solution of the present continuation application;

FIG. 35 illustrates a combination of cylindrical massage hole seat columns of the third embodiment in FIG. 32 according to the supplementary solution of the present continuation application;

FIG. 36 shows the combined arrangement of massage hole seat columns of the three embodiments in FIG. 32 on a sole according to the supplementary solution of the present continuation application;

FIG. 37 is a combined schematic diagram of massage bead spring body holder, uncompressed twisting springs and connecting members corresponding to the three embodiment types according to the supplementary solution of the present continuation application;

FIG. 38 is a schematic diagram of an insole according to the supplementary solution of the present continuation application;

FIG. 39 is a schematic diagram of a spring body insulating holder for a connecting member spring according to the supplementary solution of the present continuation application;

FIG. 40 is a state diagram of the spring body insulating holder after compression of massage beads according to the supplementary solution of the present continuation application;

FIG. 41 is a state diagram of the spring body insulating holder after compression of massage beads according to the supplementary solution of the present continuation application, with a massage hole seat further illustrated therein;

FIG. 42 shows an internal and external circuit diagram of a suspended triboelectric nanogenerator massage bead according to the supplementary solution of the present continuation application;

FIG. 43 shows an internal circuit diagram of the suspended triboelectric nanogenerator massage bead according to the supplementary solution of the present continuation application;

FIG. 44 shows a circuit diagram of a single triboelectric nanogenerator (TENG) unit according to the supplementary solution of the present continuation application;

FIG. 45 shows a circuit diagram of two triboelectric nanogenerator (TENG) units according to the supplementary solution of the present continuation application;

FIG. 46 shows a parallel layout circuit diagram of four independent triboelectric nanogenerator (TENG) units according to the supplementary solution of the present continuation application;

FIG. 47 is a structural diagram of an FEP Teflon film or a nylon film according to the supplementary solution of the present continuation application.

### DESCRIPTIONS OF REFERENCE NUMERALS

11: button; 12: projection; 13: button sleeve; 14: sliding groove; 21: massage structure; 22: massage seat; 23: ETSA; 24: Internal thread;31: twisting spring; 32: lower extension twisting arm; 33: extension arm; 34: extension spring; 35: upper extension twisting arm; 51: fixing block; 52: external supporting member; 53: trapezoidal slot; 54: massage seat; 81: bump; 82: External thread 91: hole; 101: sole; 102: massage bead; 121: material layer (insole); 521: receiving portion.

### DETAILED DESCRIPTION OF THE EMBODIMENTS

The invention will be described in more detail hereinafter with reference to the accompanying drawings showing embodiments of the invention. However, the invention may be embodied in many different forms and should not be construed as limited to the embodiments set forth herein. Rather, these embodiments are provided so that the disclosure will be thorough and complete, and will fully convey the scope of the invention to those skilled in the art. In the drawings, the size and relative sizes of layers and regions may be exaggerated for clarity.

A massage bead, a pair of shoes and a cusion according to the invention will be further described in combination with drawings and embodiments. The advantages and features of the invention will be apparent from the following description and claims.

### Embodiment 1

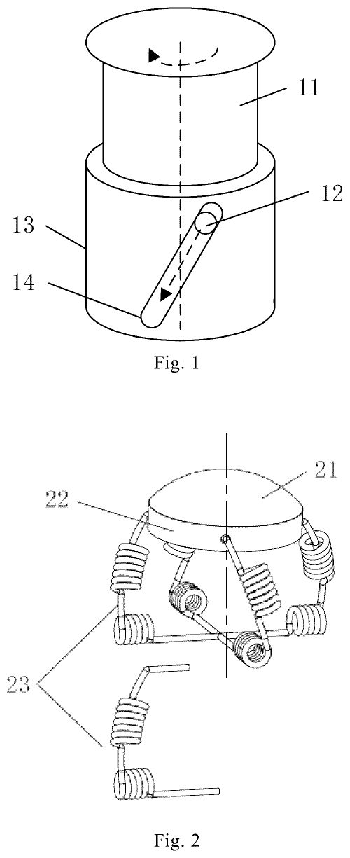

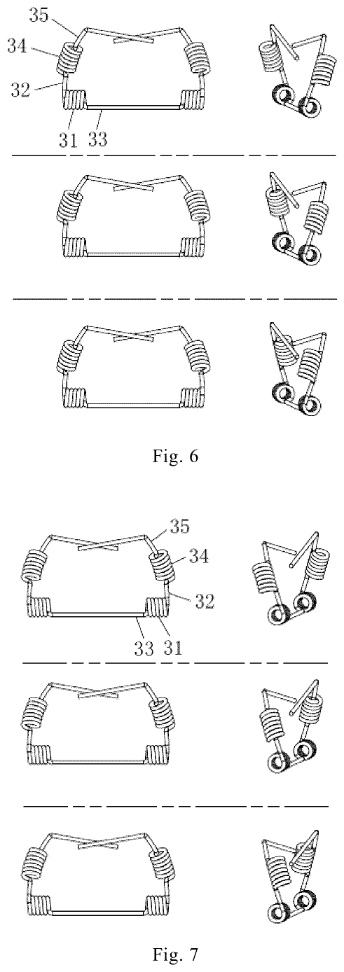

With reference to FIGS. 2 to 16, the embodiment provides a massage bead including a massage body, at least two sets of ETSAs 23 are arranged below the massage body, and the massage body is mounted on an external supporting member through a twisting spring 31 of the ETSA 23, wherein each set of the ETSAs 23 includes the twisting spring 31 and an extension spring 34; the twisting spring 31 is located below the massage body and mounted on the external supporting member, an upper end of the extension spring 34 is connected with the massage body through an upper extension twisting arm 35, and a lower end of the extension spring is connected with one upper of the twisting spring 31 through a lower extension twisting arm 32; the upper extension twisting arm 35, the extension spring 34 and the lower extension twisting arm 32 in each set that are connected with each other are arranged in a tilted manner and in a clockwise direction or in a counterclockwise direction simultaneously relative to the massage body;

when the massage body is under pressure, the ETSA 23 is compressed and twisted to generate a rotational pushing force together for pushing the massage body to rotate in the clockwise direction or in the counterclockwise direction for realizing massage effect, and deformation energy is stored when the ETSA is compressed and twisted. When the pressure exerted on the massage body disappears gradually, the energy of the ETSA releases gradually, and then the massage body resets automatically.

In the embodiment, as shown in FIG. 2, the massage bead includes four sets of twisting spring assemblies 23, and the four sets of twisting spring assemblies 23 are arranged uniformly in a circumferential direction around a center of the massage body so as to facilitate the stable rotation of the massage body. In the embodiment, the provision of four sets of twisting spring assemblies 23 causes a rotation angle of the massage body to be between 44° and 86°, which results in good massage effect. Of course, in other embodiments, the massage bead may also include two or three or five or other sets of twisting spring assemblies 23, wherein the fewer the number of sets, the larger the angle of pushing the massage body to rotate. The specific number of sets of twisting spring assemblies 23 is not limited here, and may be adjusted accordingly according to the requirements such as the rotation angle of the massage body.

Four sets of ETSAs 23 are all tilted in the clockwise direction, as shown in FIGS. 2 to 3 and FIG. 7. Or, four sets of ETSAs 23 are all tilted in the counterclockwise direction, as shown in FIGS. 4 to 5 and FIG. 6; four sets of ETSAs 23 are all tilted in the clockwise direction in the same direction, so that when the massage body is under downward pressure, the twisting spring assembly 23 is twisted to push the massage body to rotate in the clockwise direction or in the counterclockwise direction simultaneously.

In the embodiment, the extension spring 34 of each set of twisting spring assemblies 23 is arranged in a tilted manner and in a vertical direction, and the twisting spring 31 is arranged below the massage body in a transverse direction; the upper end of the extension spring 34 is connected with the massage body through the upper extension twisting arm 35, and the lower end thereof is connected with the twisting spring 31 through the lower extension twisting arm 32.

Preferably, the upper extension twisting arm 35, the extension spring 34, and the lower extension twisting arm 32 of each set are tilted at the same angle as a whole in an axial direction relative to the massage body, and a range of the tilted angle is from 4° to 46°, under which the largest rotation angle at which the massage body may be rotated is ensured while ensuring pushing the massage body to rotate, thereby improving the massage effect. Of course, in other embodiments, the specific tilted angle is not limited to the above; the angle may be adjusted according to the height of the massage body of the massage bead in the vertical direction and the rotation angle in the transverse direction, and may also be properly configured according to the actual application field of the massage bead such as the unevenness of the sole, thereby realizing rotational massage at a variety of different angles and directions.

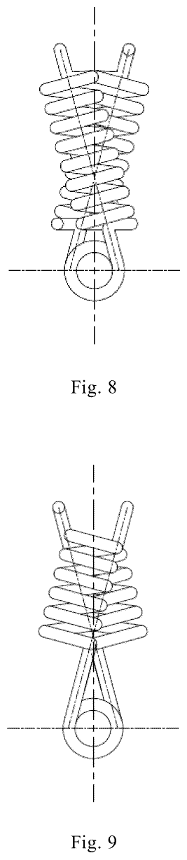

In the embodiment, the upper extension twisting arm and the lower extension twisting arm of the same set are arranged in a tilted manner at the same angle, i.e., arranged co-axially, and both the positions where the upper extension twisting arm and the lower extension twisting arm are connected to the extension spring are selected according to actual needs. With reference to FIGS. 8 to 10, an axis where two upper extension twisting arms arranged oppositely or the lower extension twisting arm is located is treated as a first axis (two), and the rotation in the clockwise direction is taken as an example, two extension springs may be arranged at outer sides and inner sides of two first axises or two first axises pass through a centerline of the extension spring (or the two first axises pass through any position in the extension spring body).

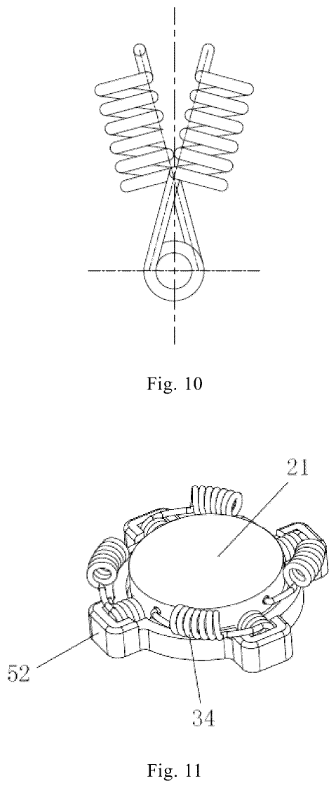

Specifically, as shown in FIG. 10, the ETSA 23 with the two extension springs arranged at the outer sides of the two first axises has a larger buffer force and a larger twisting angle, which is suitable for a heavier user with a higher requirements on the massage; as shown in FIG. 9, the ETSA 23 with the two extension spring bodies arranged at the inner sides of the two first axises has a smaller buffer force, which is suitable for a lighter user with a smaller twisting angle; as shown in FIG. 8, the ETSA 23 with the two first axises passing through the two extension springs is suitable for a user with a medium weight. Therefore, the wire diameter, spacing, number of turns, material, length, outer diameter, and height of the ETSA may be adapted according to the weight of the user.

In other words, in other embodiments, the upper extension twisting arm 35 and the lower extension twisting arm 32 are arranged in the different axises, i.e., located at the different tilted angles, and then the upper extension twisting arm 35 may slightly shift to the direction to be rotated and horizontally offset a certain angle while inserting into a side surface of the massage base 22 designed according to the angle at which the upper extension twisting arm 35 deviates horizontally; such a design may make the massage beads produce a larger rotation angle to meet the needs of different personalized people.

In the embodiment, the upper extension twisting arm 35 of the extension spring 34 is connected to an outer side of the massage body in a peripheral direction; specifically, the outer side of the massage body is provided with a mounting hole, and an end of the upper extension twisting arm 35 is inserted into the mounting hole for realizing rotational connection. In other words, in other embodiments, the rotational connection between the upper extension twisting arm 35 and the massage body is not limited to the above and may be adjusted according to specific conditions.

In the embodiment, the upper end of the twisting spring 31 is connected with the arbitrary shaped extension spring 34, and lower end of the twisting spring 31 is further provided with arbitrary shaped extension arm33, each of the extension arms33 of the ETSAs23 being connected with each other arbitrarily.

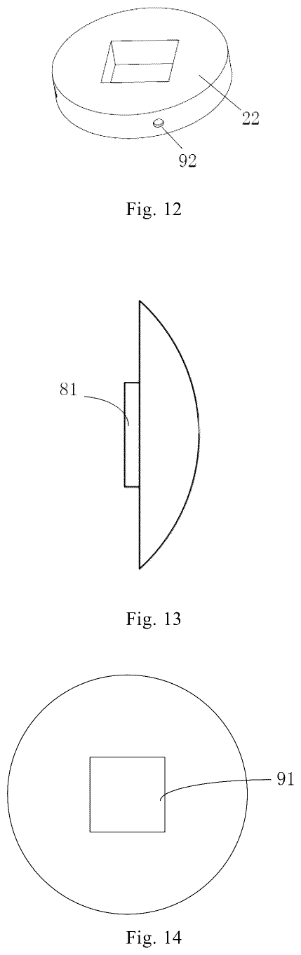

Further, an edge of the mounting hole is provided with an arc 92, as shown in FIG. 12, and this design may prevent the upper extension twisting arm 35 from wearing at right angles to the massage body.

In the embodiment, a spacing is left between the spring coils of the extension spring 34, and the wire diameter, spacing, number of turns, material, length, outer diameter, and height of the extension spring 34 and the twisting spring 31 may be adjusted according to the body weight and the unevenness of the foot sole. Through the adjustment of the material, the number of turns, the wire diameter, the spacing of coils, the elasticity, and the height of the twisting spring 31, people of different weights and the unevenness, size, and height of the foot sole may further be matched, and personalized design may be further realized, so that the user may enjoy comfortable self-massage and reaction thrust during use, thereby greatly improving the quality of life.

In the embodiment, the twisting spring 31 of each set is mounted to the external supporting member 52 horizontally, and specifically, the axial direction of the twisting spring 31 is slightly parallel to the bottom of the massage body and is arranged along a radial direction of the massage body.

Further, an extension arm 33 may be extended and connected between the twisting springs 31 respectively, and each of the extension arms 33 of the ETSAs have one end connected with the twisting spring 31 and the other ends connected with each other, thereby ensuring a relative stability among the four sets of extension twisting assemblies and the massage beads. Specifically, in the embodiment, the two twisting springs 31 arranged oppositely are connected with each other through one of the extension arms 33 respectively, the four twisting springs 31 are connected in pairs by two of the extension arms 33, and the two extension arms 33 are arranged at 90° in a cross, and the intersections are fixedly connected to each other. In other words, in other embodiments, the connection mode between the twisting springs 31 is not limited to the above and may be adjusted arbitrarily according to specific conditions.

In the embodiment, preferably, the upper extension twisting arm 35, the extension spring 34, the lower extension twisting arm 32, the twisting spring 31, and the extension 33 included in each set of corresponding twisting spring assemblies 23 are integrally formed, i.e., the two sets of corresponding twisting spring assemblies 23 share an extension arm so as to further be integrally formed, wherein being integrally formed may ensure that the ETSA 23 formed in combination is stronger.

Further, the material of the ETSA 23 may be configured as metal, alloy material, or other synthetic or composite material with good toughness, elasticity, and supporting force. The rotation of the massage beads is realized by the repeated twisting of the ETSA 23 and the reset of the twisting spring 31. Those skilled in the art can freely set parameters such as the material, size, wire diameter, and length of the ETSA 23 according to the needs of the application field of the massage bead, which are all included in the scope of the embodiment.

In the embodiment, the massage beads are fixedly mounted by mounting the twisting spring 31 on the external supporting member 52; the external supporting member 52 may be a base, and then the base is mounted to the supporting members such as the sole; the external supporting member 52 may also be integrally formed directly with supporting members such as soles, insoles, mats, etc., which is not limited here.

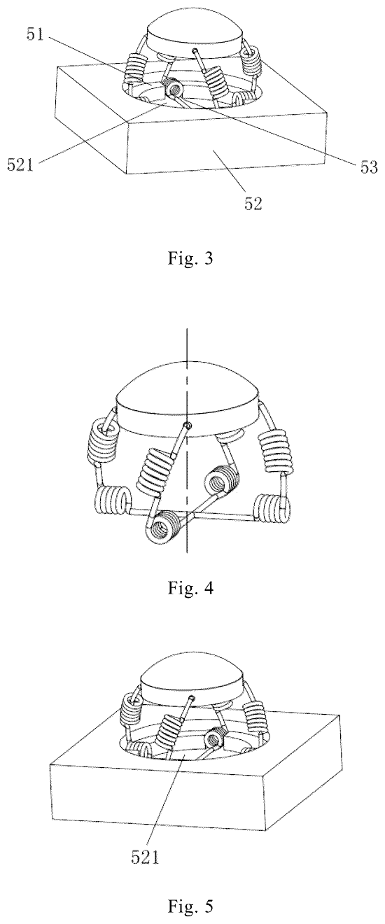

Specifically, as shown in FIG. 3, a position where the external supporting member 52 corresponds to the twisting spring 31 is provided with a trapezoidal slot 53 for receiving each of the twisting springs 31 and the extension arms 33, and a fixing block 51 is further provided between adjacent twisting springs 31, so that the trapezoidal slot 53 formed between adjacent fixing blocks 51 is used to fix the twisting spring 31 and prevent the twisting spring from moving; preferably, the size of the trapezoidal slot 53 is slightly smaller than that of the twisting spring 31 so as to compress the twisting spring 31, and the bottom of the external supporting member 52 may also be provided with a slot so as to insert the extension arm of the twisting spring 31 therein.

In other words, in other preferred embodiments, the connection mode between the twisting spring 31 and the external supporting member 52 is not limited to the above, i.e., the fixing block 51 may also be replaced with other structures such as a porous block, a hollow block, etc. arranged on the supporting member, wherein the porous block and the hollow block may reduce weight with the identical effect of the fixing block 51, or the fixed connection with the supporting member is performed by plugging, mortise and tenon, buckle, glue or fastening device, so as to play the role of fixing the twisting spring 31 (or the fixing block, the porous block, the hollow block, and the supporting member are integrally formed) with the working process that will not be repeated here.

In the embodiment, a position of the external supporting member corresponding to the massage bead is provided with a receiving portion 521; when the massage body is forced to be rotated and pressed downward completely, the ETSA 23 may be received in the receiving portion for preventing the ETSA 23 from interfering with the external supporting member, so as to ensure the normal rotation of the massage body. Further, the receiving porting may be implemented as a notch provided on the external supporting member, as shown in FIG. 11; in other words, in other embodiments, the implementation of the receiving portion is not limited to the above and may also be adjusted according to specific conditions.

In the embodiment, the massage body includes a massage base 22 and a massage structure 21, wherein the massage structure is arranged on an upper end surface of the massage base, and the upper extension twisting arm 35 is connected to the massage base 22. In other words, in other embodiments, the upper extension twisting arm 35 may also be connected to the massage base 22 and connected to the massage structure 21 in any combination. Or, the massage base 22 may also be integrally formed with the massage structure 21 as an integral structure, and the upper extension twisting arm 35 may be directly connected to the massage body, which will not be repeated here and may be selected according to actual needs.

In the embodiment, as shown in FIG. 13, an upper portion of the massage structure 21 may be configured as a smooth hemispherical convex structure. When the massage structure 21 is under pressure to be rotated under the operation of the entire massage bead, the smooth hemispherical convex structure rotates and acts on the object to be massaged, providing a gentle rotational massage. In other preferred embodiments, the upper portion of the massage structure 21 may also be configured as a semi-elliptical spherical body, or the upper portion of the massage structure 21 may also be configured as a combination structure of a plurality of grooves and/or raised semicircular or semi-elliptical convex surfaces with preset patterns, such as arranging raised points, cross raised patterns or other forms of raised pattern structures on convex structures. The surface of the massage structure 21 may also be provided with grooves of various patterns, or protrusions and grooves may be provided at the same time. The provision of the protrusion and/or the groove structure may further improve the massage effect and improve the massage experience. In other words, the upper portion of the massage structure 21 may also be configured as a rough semicircular or semi-elliptical convex composite structure. Those skilled in the art may freely configure the surface structure of the massage structure 21 according to the actual needs of the application field of massage beads, which are all included in the scope of the embodiment.

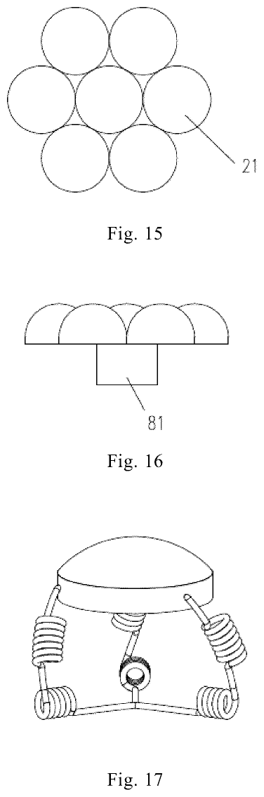

In other embodiments, with reference to FIGS. 15 and 16, the massage structure may be a plurality of small hemispheres, which is beneficial to the large-angle rotation of the massage beads, and provides a multi-point rotational massage experience. The small hemispherical massage structure 21 may be integrally formed and arranged on the massage base, or integrally formed with the massage base to form a multi-spherical massage body, wherein the spheres may be any combination of hemispheroids and/or semi-elliptical spheres, and the spheres may be evenly distributed or irregularly distributed, which may further improve the massage effect and improve the massage experience.

In the embodiment, the massage base 22 is connected with the massage structure 21 by connecting members.

Specifically, with reference to FIGS. 13 to 14, a lower portion of the massage structure 21 is provided with a first connecting member, and the massage base 22 is provided with a second connecting member correspondingly. The massage structure 21 is connected with the second connecting member of the massage base 22 by the first connecting member, wherein the first connecting member and the second connecting member may be connected in any combination of plug-in, mortise, and tenon, and matching methods of projections and grooves.

Further, in the embodiment, the first connecting member on the lower portion of the massage structure 21 is a bump 81, and correspondingly, the second connecting member on the massage base 22 is a matching hole 91, so that the massage structure 21 is fixedly connected to the massage base 22 by inserting the bump 81 into the hole 91 and the auxiliary fixing of the socket, mortise and tenon and environmental glue.

In the embodiment, cross-sectional shapes of the bump 81 and the hole 91 are squares, which is used to prevent mutual rotation. In other words, in other embodiments, the cross-sectional shape of the bump 81 and the hole 91 may also be other polygons or other regular or irregular shapes, which are not limited here and may be adjusted according to specific conditions.

Further, in the embodiment, the massage base 22 is a disc structure with the hole 91, and the structure is round on the outside and square on the inside, which is similar to ancient coins; a side of the massage structure 21 provided with the bump 81 is a planar structure. When the massage structure 21 is mounted and fixed with the massage base 22 by the bump 81 and the hole 91, the sides where the two are connected are flat to achieve a flat fit, improving the structural stability of the two after mounting and fitting. In other words, in other embodiments, the hole 91 may also not pass through the massage base 22, which is not limited here.

The connection mode between the massage base 22 and the massage structure 21 is not limited to the above description; for example, the first connecting member may also be a hollow structure, and the second connecting member is a bump structure; for example, the number of the first connecting member and the second connecting member may also be multiple; and for example, the provisions of the first connecting member and the second connecting member may be omitted, and the massage base 22 and the massage structure 21 are directly fixed with each other by glue as long as the fixing between the two can be realized, which is not limited here.

Preferably, materials of the massage structure 21 are stone needles or other stone, wood, medicinal material, pure material, composite, or synthetic material, and any combinations thereof, which may be selected according to actual needs and is not limited here.

When the material of the massage structure 21 is the stone, the stone may be jade, magnetite, germanium, diamond longevity stone or diamond medicine stone, tourmaline, obsidian, garnet, malachite, peridot, citrine, maifan stone, or medical stone.

The material of the massage structure 21 is the stone needle, which is originated from “Insufficient of Shen (Spirit), the weak Collaterals are pressed to enrich [Qi].” in On Regulating Meridians, Chapter 62, General Questions and Answers From Huange Di's Inner Classic. Section 12 of Discussion on Different Therapeutic Methods for Different Diseases (YIfa Fangyi Lunpian) of Yellow Emperor's Canon of Medicine Plain Conversation (Huangdi Neijing Suwen) says: “For example, the east is the place where all the things in nature start to grow. The east is near the sea and is rich in fish and salt. People there prefer fish and salty taste. They live in satisfaction and enjoy rich food. But excessive fish food tends to accumulate heat in the body and excessive salty flavor is likely to impair blood. That is why people there look block in skin and are loose in muscular interstices. They frequently suffer from Yong (carbuncle) and Yang (ulcer) that can be cured by stone-needle. In fact, the stone needle was developed in the east.” Therefore, the selection of the stone needle for the material of the massage body only brings some additional effects, and does not affect the integrity of the technical solution of the application.

Arranging the stone needle on the massage seat as the massage structure 21, in combination of the ETSA 23, may control the rotation of the stone needle at a precise angle when being under pressure with a rotation angle greater than the normal massage button, thereby realizing good massage experience. The massage bead effectively solves the problem that the massage with existing stone needles may only perform large-angle rotational massage manually and may not realize foot massage during walking. The massage bead provided in the embodiment achieves good effects of light weight, flexible rotation, and connection between the preceding and the following, and are more practical when used on other carriers.

The purpose of material selection is to better achieve the effect of foot massage. The above-mentioned different types of massage structures 21 may be rotated precisely at a large angle when receiving pressure through the cooperation of the ETSA 23 of the massage bead and the massage seat 22, and in combination of different materials of the massage structures 21, the massage effect is improved so as to provide a better massage experience to the user.

In the embodiment, the material of the massage seat 22 is carbon fiber, pure material, composite material or synthetic material, etc., which are not limited here and may be selected according to specific conditions.

When the material of the massage seat 22 is carbon fiber, this material is light in texture, stable in structure, high temperature resistant, friction-resistant, and corrosion-resistant and makes the overall structure lighter when being used in the massage bead structure; when the massage bead is applied on different carriers, the weight of the overall structure may be effectively reduced, and the number of massage beads may be adjusted to improve the massage experience. Since the massage seat 22 is made of wear-resistant carbon fiber material, the additional wear and tear will be less when the massage bead is used repeatedly.

In summary, the massage bead provided in the embodiment may realize large-scale rotation under the action of its own pressure, and automatically reset when the pressure decreases or disappears. Through the combination of the ETSA and the massage seat 22, large-angle massage without relying on manual work may be realized, so that the friction loss is smaller as compared with other existing massage structures, making the massage bead of the embodiment more durable.

The different sizes, wire diameters, number of turns, quantity and material settings of the ETSA 23 may be flexibly changed to meet various demands. According to different situations such as the weight of the human body and the unevenness of the foot sole, different ETSAs 23 may be designed to make the massage experience more comfortable.

The massage bead has a simple structure and light weight, and are suitable for massage applications in various scenarios. When the massage bead is applied on different carriers (such as a pair of shoes, insoles, etc.), the application range and massage experience will be more abundant. The massage bead may provide the user with more comprehensive, balanced and comfortable massage effects in different scenarios.

### Embodiment 2

With reference to FIGS. 17 to 18, the embodiment is an adjustment based on Embodiment 1.

Specifically, in the embodiment, the massage bead includes three sets of twisting spring assemblies 23, and the three sets of twisting spring assemblies 23 are arranged uniformly in a circumferential direction around a center of the massage body. The three twisting springs 31 are respectively extended with an extension arm 33, and each set of ETSAs 23 is integrally formed; three extension arms 33 are arranged at intervals of 120°, and one end of the extension arms 33 are connected to the twisting springs 31, and the other ends thereof are connected to each other, which may be connected by any means such as pressing, hot melting, hook welding or/and glue.

In the embodiment, for other structures of the massage bead, reference can be made to the description in Embodiment 1, which is not limited here.

The massage bead provided in the embodiment is only provided with three sets of twisting spring assemblies 23, which causes the rotation angle of the massage body to reach from 94° to 116°, has a larger rotation angle and a better massage effect as compared with the four sets of twisting spring assemblies 23 in the embodiment.

### Embodiment 3

The embodiment is an adjustment based on Embodiment 2.

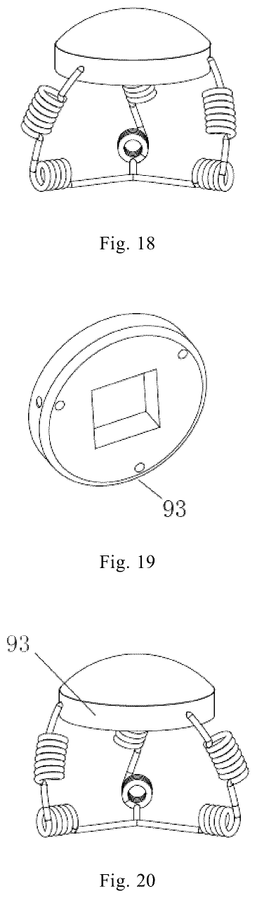

With reference to FIGS. 19 to 20, in the embodiment, the outer side of the massage body is provided with an earring hole 93 (an edge of the earring hole is still provided with the arc), and the end of the upper extension twisting arm is connected with the earring hole 93 in a buckle manner.

In the embodiment, for other structures of the massage bead, reference can be made to the description in Embodiment 2, which is not limited here.

### Embodiment 4

The embodiment is an adjustment based on Embodiment 1.

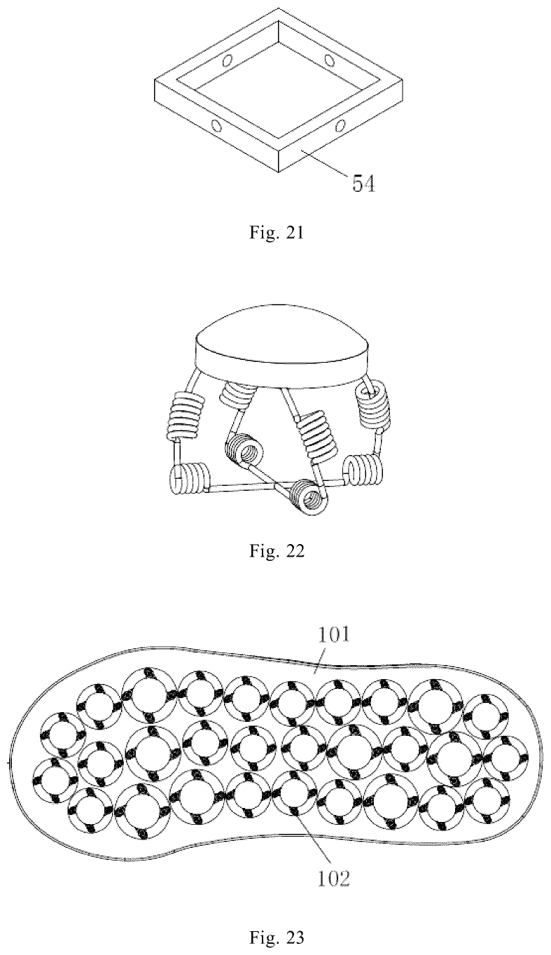

With reference to FIGS. 21 to 22, in the embodiment, here, the massage seat 54 is located below the massage structure and smaller than the massage structure; the outer side of the massage seat is provided with a mounting hole or the earring hole 93 (edges of the mounting hole and the earring hole are still provided with the arc), and the end of the upper extension twisting arm is inserted, snapped, welded, or connected with the earring hole 93 in any combination with the mounting hole.

In the embodiment, for other structures of the massage bead, reference can be made to the description in Embodiment 1, which is not limited here.

In another special case of the embodiment, the massage seat and the massage structure is arranged to be integrally formed (i.e., the massage body), the mounting hole or the earring hole 93 (edges of the mounting hole and the earring hole are still provided with the arc) is distributed uniformly on the inner side or the outer side of the peripheral direction of the massage body, and the end of the upper extension twisting arm is inserted, welded, or connected with the earring hole 93 in any combination with the mounting hole.

In the embodiment, for other structures of the massage bead, reference can be made to the description in Embodiment 1, which is not limited here.

### Embodiment 5

With reference to FIG. 23, the embodiment provides a pair of shoes, which includes the massage bead 102 according to Embodiment 1 or Embodiment 2. Specifically, the massage bead 102 may be arranged inside the insole.

When the massage bead is arranged inside the insole, the insole is provided with a plurality of massage beads 102 according to the above embodiments. In the embodiment, the insole is treated as a carrier, the insole is provided with a plurality of holes (or grooves) to receive the massage bead 102, and the insole may be directly placed in the shoe as an independent body and may also be replaced. The position of the massage bead 102 may be configured according to the needs of the acupoints on the foot soles, and the quantity and size of the massage bead 102 may be configured according to actual needs. Similarly, the rotation angle and the moving distance under pressure for the massage bead 102 itself may be adjusted as required. Those skilled in the art can freely set the number of massage bead 102 and the specific size and material of each part structure according to the different massage needs of the insole or cushion with massage function when facing different users, which are all included in the scope of the embodiment.

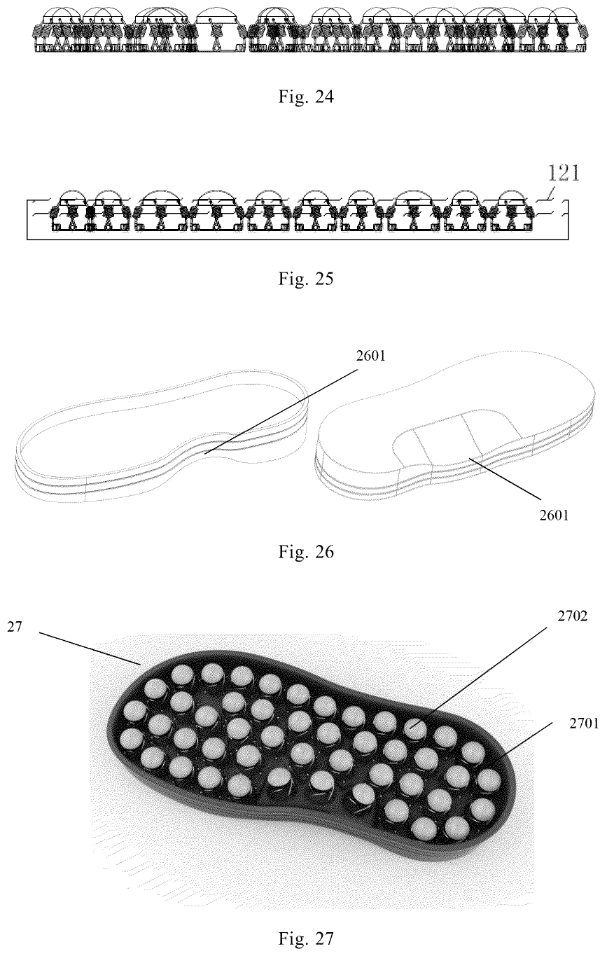

When the massage bead 102 is arranged in the sole 101, the sole 101 of the embodiment receives and compresses the ETSA through the trapezoidal slot 53, and further fixes the twisting spring and the extension arm at the bottom of the massage bead 102, wherein the trapezoidal slot 53 may be arranged on the sole, with a size slightly smaller than the bottom of the massage bead 102, the twisting spring and the extension arm at the bottom; the massage bead 102 may also be fixed in the base 52 by fixing means, glue, etc., preferably without affecting the twisting effect of the massage bead. With reference to FIG. 24, the depth of the trapezoidal slot 53 is configured to be the same as or close to the height of the twisting spring in the massage bead 102 structure. When the massage bead 102 is stressed, in addition to being able to rotate on the horizontal plane where the sole 101 is located, the massage bead may also move up and down relatively substantially in the vertical direction of the sole 101, with a maximum amplitude reaching the vertical distance between the lower plane of the massage seat 22 and the bottom extension arm of the twisting spring. The sole may be covered with an insole (all kinds of material layers 121) at the same position as the massage bead on the sole; with reference to FIG. 25, each massage bead is properly covered, and only the massage structure 21 is exposed. This way, by using the shoe with the massage function, an aesthetically pleasing, safe, and large-angle massage experience may be realized, and the massage effect on the foot sole is better.

Preferably, the insole where the massage bead is placed may be made of wood, medicinal material, pure material, composite or synthetic material, and the insole made of sandalwood also has the effects of reducing swelling, relieving pain, and regulating Qi and blood. The thirty-fourth volume of the main part of Li Shizhen's “Compendium of Materia Medica” said: Red sandalwood tastes salty, slightly cold, non-toxic, and can harmonize nutrient Qi to reduce swelling and poison. Pterocarpus santalinus can stop bleeding, relieve pain, and regulate Qi and blood.” The insole made of any combination of the above materials is included within the scope of the embodiment.

### Embodiment 6

The embodiment provides a cushion, which includes the massage bead 102 according to Embodiment 1 or Embodiment 2. The cushion is provided with a plurality of massage beads 102 according to the above embodiments. The cushion serves as a carrier, and the cushion is provided with a plurality of holes to receive the massage bead 102.

The cushion may be a yoga cushion, a seat cushion, a foot cushion, etc., and may also be laid flat on the ground, so that people can directly step on their feet for massage during leisure. The material of the cushion itself may be selected freely according to its application field. The hole provided on the cushion may cooperate with the necessary fixing device to make the twisting spring at the bottom of the massage bead 102 relatively fixed to the cushion without affecting the twisting of the twisting spring. The fixing device here may be configured as required to be connected with the cushion by inserting, mortise and tenon, buckle, glue or fastening device, and may also be integrated with the cushion. The position of the massage bead 102 may be configured according to the different positions required for the cushion, and the number of the massage bead 102 may be configured according to the massage effect as required. Similarly, the rotation angle and the moving distance under pressure for the massage bead 102 itself may be adjusted as required. Those skilled in the art can freely set the number, the size of massage bead 102, and the specific size and material of each part structure according to the different massage needs of the cushion with massage function when facing different users, which are all included in the scope of the embodiment.

In actual use, the positions of the massage bead may be placed arbitrarily. The outer diameter, the shape of the top and radian of the massage structure, the outer diameter of the massage seat, and the length and height of the ETSA may be adjusted arbitrarily, so that the size of the massage bead may be adjusted arbitrarily. For example, the outer diameter of the massage structure is smaller than, equal to, or larger than the outer diameter of the massage seat, or the outer diameter of the massage seat is less than or equal to the length of two sets of ETSAs that are integrally formed, or the outer diameter of the massage structure is less than or equal to the length of two sets of ETSAs that are integrally formed.

The implementations of the present invention are described in detail above with reference to the accompanying drawings, but the present invention is not limited to the above implementations. Even if various changes are made to the present invention, if these changes fall within the scope of the claims of the present invention and equivalent technologies, they still fall within the protection scope of the present invention.

The present application is an improvement and supplement made on the basis of the parent U.S. patent application Ser. No. 18/307,616 entitled “MASSAGE BEAD, A PAIR OF SHOES AND CUSHION”, with the specific contents as follows:

Supplementary Solution 1 relates to a combined massage structure, which will be described below with reference to FIGS. 26 to 41.

A plurality of massage hole seats 2701 are arranged on the massage base plate 26 shown in FIG. 26, as illustrated in FIG. 27. The massage hole seats 2701 may be provided in various shapes. The massage hole seats of different shapes can be assembled and fixed inside the massage base plate by means of adhesive bonding, mortise and tenon connection or the like, or the massage hole seats 2701 in any shape can be integrally formed and fixed on the massage base plate. The massage bead 2702 for a single massage contact and the spring body insulating holder (see FIG. 30) are disposed inside each of the massage hole seats 2701. In response to changes in the curved surface of the foot sole, the massage hole seats 2701 and the matched massage beads 2702 can be inclined as a whole in any manner to adapt to the curved surface of the foot sole. Meanwhile, the thicknesses of the massage hole seats 2701 and the massage base plate can be adjusted as required. During installation, the spring body insulating holder (FIG. 30) is first placed into the massage hole seat 2701, and then the twisting spring of the massage bead 2702 is mounted in the spring body insulating holder, so that the massage bead protrudes above the massage base plate 26.

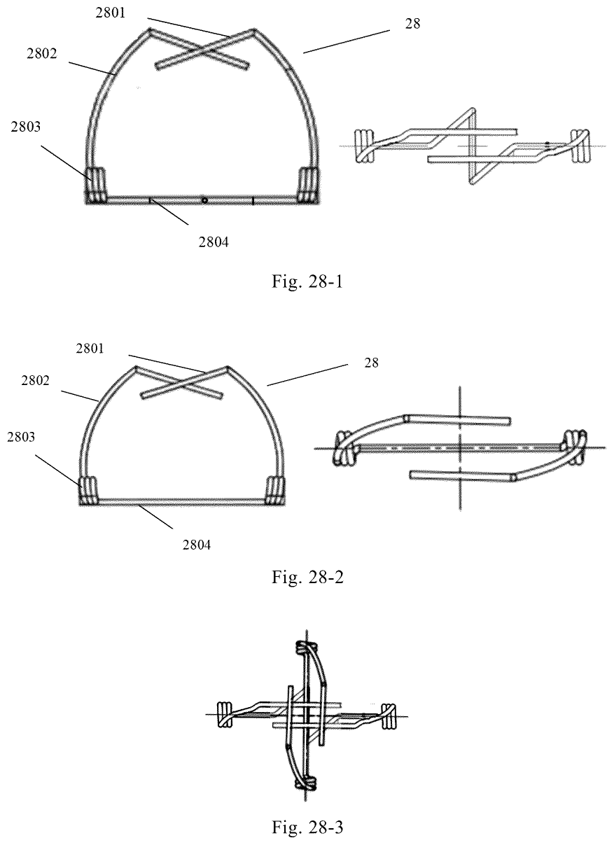

FIG. 28 illustrates three embodiments of the spring body in FIG. 27. FIG. 28-1 shows a side view and a top view of a spring body 28 with a Z-shaped spring at the bottom. The spring body 28 comprises straight spring arms 2801, curved spring arms 2802 and twisting springs 2803, which are arranged symmetrically in pairs from top to bottom. One end of each pair of straight spring arms 2801 is suspended, and the other end thereof bends and extends downward via a pair of connected curved spring arms 2802 to be connected to a pair of twisting springs 2803, with a extension arm 2804 formed between the twisting springs 2803. The extension arm 2804 is connected between the pair of twisting springs 2803, and the extension arm 2804 is Z-shaped (as shown in the top view of FIG. 28-1).

FIG. 28-2 shows a spring body 28 with an “-” shaped spring at the bottom. This spring body 28 likewise includes two symmetrical structures composed of straight spring arms 2801, curved spring arms 2802 and twisting springs 2803 which are symmetrically arranged in pairs. An extension arm 2804 connects the two symmetrical structures. Different from FIG. 28-1, the extension arm 2804 is “-” shaped (as shown in the top view of FIG. 28-2). It will be understood by those skilled in the art that other shapes and combinations of extension arms may be adopted without departing from the scope of the present invention.

FIG. 28-3 shows a combination of the spring bodies according to the two embodiments of FIG. 28-1 and FIG. 28-2. The spring body with “-” shaped spring at the bottom and the spring body with Z-shaped spring at the bottom are disposed to overlap at an angle, preferably perpendicularly. The combination of the “-” shaped spring and the Z-shaped spring can increase the bottom contact area. The bottom contact portions of the “-” shaped spring and the Z-shaped spring are connected by welding processes such as fusion welding to enhance structural stability. Optionally, the “-” shaped spring and the Z-shaped spring may be integrally formed; alternatively, the extension arms of the Z-shaped and “-” shaped spring bodies may be connected to one another by welding, either independently or in combination.

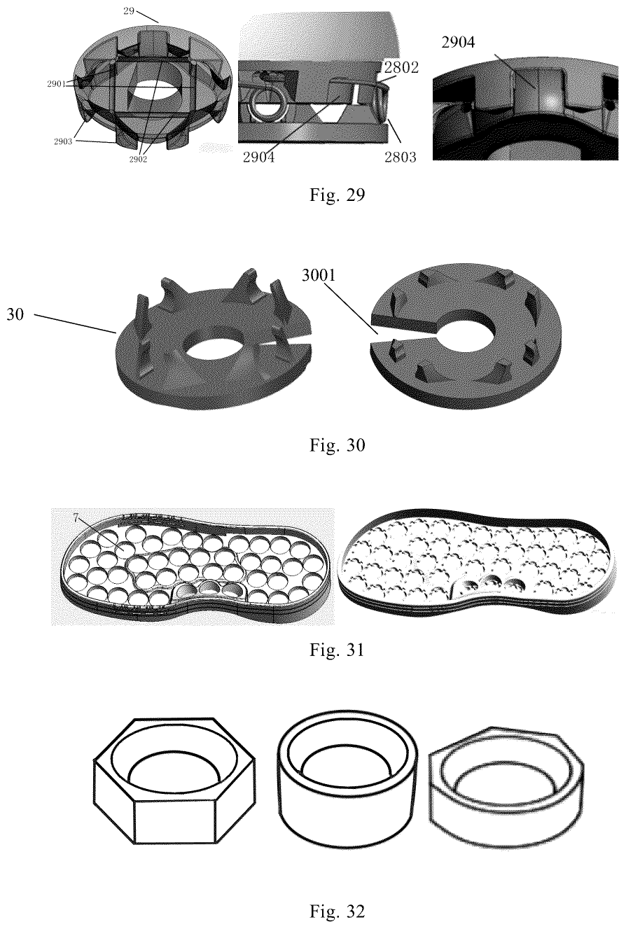

FIG. 29 is a schematic diagram of a connecting member according to supplementary solution 1 of the present continuation application, showing partial structural details of the connecting member. As illustrated, a massage structure is fixedly connected to an upper portion of the connecting member 29. The massage structure is secured to the connecting member by mortise and tenon connection or adhesive bonding, and pressing down the massage structure enables pressing down the connecting member 29. The connecting member 29 is provided with two clockwise straight spring arm cavities 2901 and two counterclockwise straight spring arm cavities 2902. The clockwise straight spring arms 2801 (FIG. 28) are inserted into the clockwise straight spring arm cavities 2901. When the connecting member 29 is pressed downward, the massage bead rotates clockwise under the action of the curved spring arms 2802 (FIG. 28).

Similarly, counterclockwise rotational massage can also be realized. The counterclockwise straight spring arms are inserted into the counterclockwise straight spring arm cavities 2902. When the connecting member is pressed downward, the massage bead rotates counterclockwise under the action of the curved spring arms, which will not be elaborated repeatedly herein. As shown in FIG. 29, the connecting member 29 is further provided with limiting blocks 2903 for limiting the curved spring arms, so as to ensure that the curved spring arms twist and operate within a limited area during the downward pressing of the massage structure, thereby guaranteeing operational safety. The diameter of the connecting member 29 is equivalent to the diameters of the massage structure and the massage hole seat. A plurality of ramps 2904 are arranged on the connecting member 29 at positions adjacent to the limiting blocks 2903. After the massage structure and the connecting member are pressed down, the ramps 2904 on the connecting member can push the curved spring arms 2802 (FIG. 28) outward to prevent abrasion between the curved spring arms and the twisting springs 2803 (FIG. 28). These ramps 2904, together with the massage structure, enclose all the spring arms 2801, 2802 and the twisting springs 2803 in the space defined by the connecting member 29 and the massage hole seat. When the massage structure is subjected to downward pressure, the spring body twists and drives the connecting member 29 to rotate and descend.

FIG. 30 illustrates the spring body insulating holder 30 disposed on the connecting member in FIG. 29 according to supplementary solution 1 of the present continuation application; FIG. 31 shows two embodiments of the massage base plate according to the supplementary solution of the present continuation application. As shown in FIG. 30, a notch 3001 is provided on one side of the spring body insulating holder 30. The notch 3001 is compressed to temporarily reduce the outer diameter of the spring body insulating holder 30, the spring body insulating holder 30 is placed into the sole massage holes 7 shown in FIG. 31, and then released to achieve a tight fit with the massage holes 7. The shape of the interface portion between the spring body insulating holder 30 and the inner side of the massage hole seat 7 may be a regular shape such as a circle or a square, or mutually mated concave-convex engagement structures, or a combination of regular shapes and concave-convex structures, the outer contour shape of the massage hole seat is circular, hexagonal, or a mixed shape of arcs and polygons, and the overall massage hole seat adopts a combined structure of cylinder, polygonal cylinder, or mixed cylinder with arcs and polygons. The spring body insulating holder 30 is made of insulating materials such as PEEK and POM.

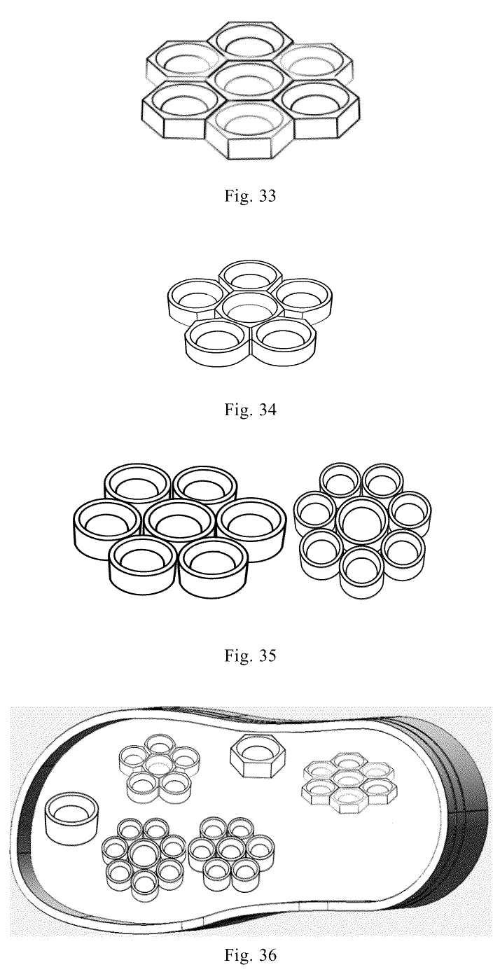

FIG. 32 shows three embodiments of the massage hole seat according to supplementary solution 1 of the present continuation application, namely a hexagonal massage hole seat, a cylindrical massage hole seat and a hybrid polygonal massage hole seat. The hybrid polygonal massage hole seat shown in FIG. 32 has edges combining arc segments and regular straight sides. Naturally, other irregular edges and combinations thereof are also applicable. FIG. 33 illustrates a combination of hexagonal massage hole seat columns in FIG. 32; FIG. 34 illustrates a combination of hybrid polygonal massage hole seat columns in FIG. 32; FIG. 35 illustrates a combination of cylindrical massage hole seat columns in FIG. 32.

FIG. 36 shows the combined arrangement of the massage hole seat columns of the three embodiments in FIG. 33 on the sole according to supplementary solution 1 of the present continuation application. As shown in FIG. 36, the combinations of massage hole seats and massage hole seat columns in different forms shown in FIGS. 32 to 35 are disposed on the massage base plate in various combinations.

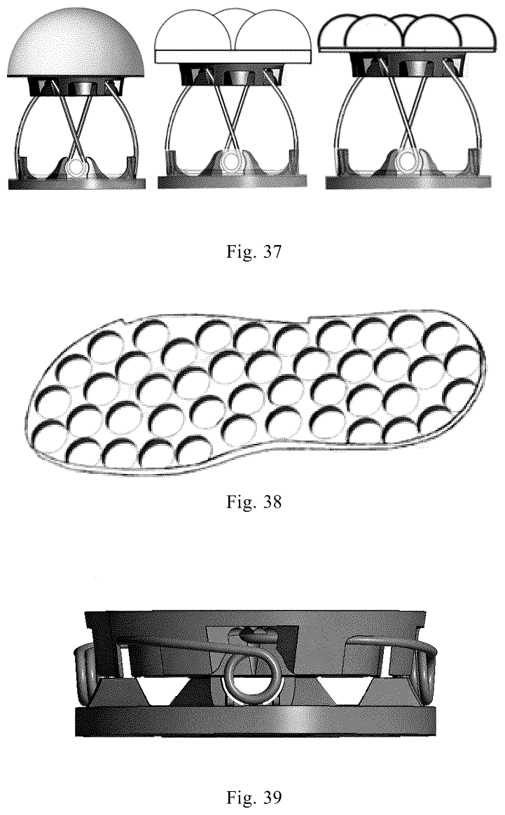

FIG. 37 is a combined schematic diagram of massage bead spring holders, spring bodies and connecting members corresponding to the three embodiment types of supplementary solution 1 of the present continuation application. Illustrated therein are embodiments in which a massage structure for a single massage contact corresponds to one connecting member, a massage structure for three massage contacts corresponds to one connecting member, and a massage structure for seven massage contacts corresponds to one connecting member. The combined massage structure includes massage beads, spring body insulating holders and massage hole seats, wherein each massage bead comprises a massage structure, a connecting member and a spring body. The connecting member is fixedly connected to the massage structure. The straight spring arms are fittingly inserted into the straight spring arm cavities of the connecting member in a clearance fit manner, and the straight spring arms are capable of circumferential rotation relative to the straight spring arm cavities. The curved torsion arms of the spring body are connected with the twisting springs, and the twisting springs are snapped into the spring body insulating holders. When a dynamic balance is achieved between human body gravity and the elastic force of the spring body, suspended massage can be realized. The massage beads are compressed under the pressing force of human body gravity; when the pressure is removed, the massage beads automatically reset under the elastic action of the curved spring arms and the twisting springs.

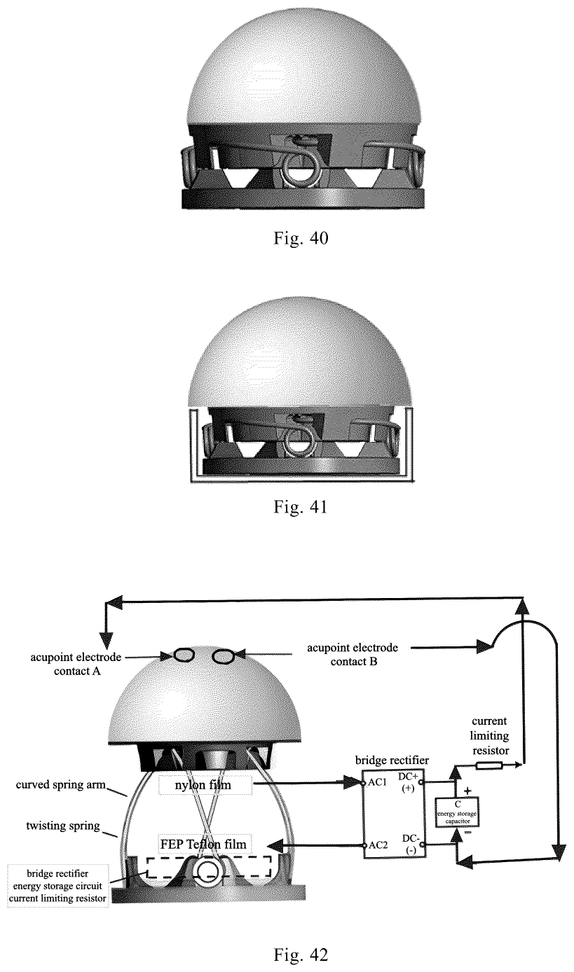

FIG. 38 is a schematic diagram of an insole according to supplementary solution 1 of the present continuation application. FIG. 39 is a schematic diagram of a spring insulating holder for a connecting member spring according to supplementary solution 1 of the present continuation application. FIG. 40 is a state diagram of the spring insulating holder after compression of the massage bead according to supplementary solution 1 of the present continuation application. FIG. 41 is a state diagram of the connecting member, the spring insulating holder and the massage hole seat after compression of the massage bead according to supplementary solution 1 of the present continuation application.

Compared with the prior art, the technical solution proposed in supplementary solution 1 has the following beneficial effects:

Strong personalized adaptability: since the massage beads adopt a modular design, the quantity, arrangement positions and specifications of massage structures of the massage beads can be adjusted according to the user's foot shape, acupoint distribution and pressure tolerance. Multiple types of springs and rigid components are optional to flexibly adjust massage intensity and cushioning performance. The structure can bear pressure and absorb impact force, relieve plantar stress fatigue, and meet the demands of different people.

High structural stability and durability: the combined massage structure improves the stability of each unit in the combined massage mode. Since metal components such as springs are adopted as auxiliary parts, compared with traditional foam or rubber materials, the structure possesses superior fatigue resistance and prolongs the service life of the product.

Wide application range: the suspended triboelectric nanogenerator massage beads can be flexibly integrated into insoles or base plates. By adjusting the array arrangement and unit specifications of the massage beads, the massage beads are applicable to various shoe types including sports shoes, leather shoes and casual shoes. Meanwhile, no external power supply is needed, the product can be used in multiple scenarios such as commuting, sports and household use, which greatly enhances product utility.

Supplementary solution 2 relates to a suspended triboelectric nanogenerator massage bead based on the principle of the triboelectric nanogenerator (TENG), it realizes a novel massage bead structure with self-power supply, suspension buffering and massage functions. The core power generation principle of the triboelectric nanogenerator (TENG) is as follows: a nylon film and an FEP Teflon film generate triboelectrification and accumulate static charges during continuous cyclic contact-separation motion, the separation of friction layers creates a potential difference and further triggers an electrostatic induction effect. Through the cyclic motion of continuous contact electrification, separation and reset of the friction layers, static charges continuously accumulate at the friction interface, and electrostatic induction is continuously generated during the separation process. Thus, the first back electrode and the second back electrode periodically induce alternating charges to output alternating current. The suspended triboelectric nanogenerator massage bead of supplementary solution 2 is characterized in that the power generation principle of the triboelectric nanogenerator (TENG) is combined with the pressing and rotating motion of the massage bead. Independent friction medium layers are provided in the massage bead. With human body pressure and the elastic force of torsion springs, the nylon film and the FEP Teflon film perform continuous and reciprocating motion of contact electrification and separation. The friction layers are separated to form a potential difference and produce an electrostatic induction effect. Static charges keep accumulating at the friction interface, and electrostatic induction occurs continuously in the separation process, such that the first back electrode and the second back electrode periodically induce alternating charges and output alternating current.

The suspended triboelectric nanogenerator massage bead according to supplementary solution 2 will now be described with reference to FIGS. 42 to 47.

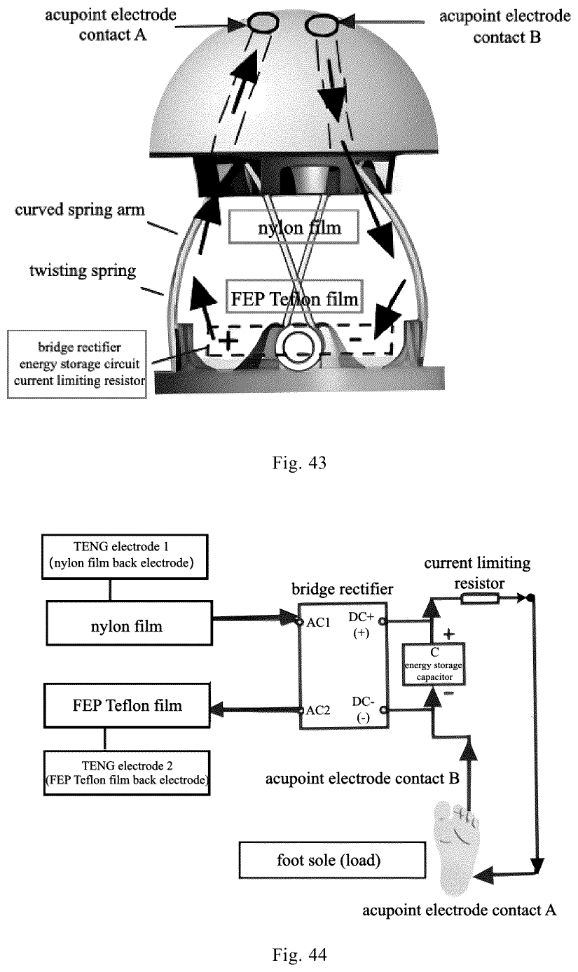

FIG. 42 is a circuit schematic diagram of the suspended triboelectric nanogenerator massage bead according to supplementary solution 2 of the present continuation application; FIG. 43 is an internal circuit diagram of the suspended triboelectric nanogenerator massage bead according to the supplementary solution of the present continuation application; and FIG. 44 is a circuit diagram of a single independent TENG power generation unit according to the supplementary solution of the present continuation application. As shown in FIGS. 42 to 44, the circuit schematic of the suspended triboelectric nanogenerator massage bead, the internal circuit diagram of the massage bead, and the circuit diagram of the single independent TENG power generation unit illustrate that the suspended triboelectric nanogenerator massage bead includes: a combined massage assembly, a triboelectric power generation assembly, a current-limiting resistor, and working electrodes.

The combined massage assembly includes the massage bead, the spring body insulating holder and the massage hole seat described above in conjunction with supplementary solution 1, and the connection structure thereof has been described in FIG. 37, which will not be repeated herein. The triboelectric power generation assembly further includes independent friction medium layers. As shown in these Figures, the independent friction medium layers form a friction pair composed of a nylon film and an FEP Teflon film. These two films are disposed opposite to each other, and are respectively fixed inside the massage bead and insulatively connected to the connecting member, as well as insulatively fixed on a compact flexible printed circuit board integrated with a rectifier bridge, an energy storage capacitor and a current-limiting resistor at the bottom, wherein the vertical stacking order of the two films is interchangeable.

The back electrodes include a first back electrode disposed corresponding to the nylon film and a second back electrode disposed corresponding to the FEP Teflon film. The first back electrode and the second back electrode are respectively arranged on the back sides of the corresponding insulating films to conduct the alternating charges induced on the back electrodes and output alternating current. Repeated external pressing on the massage bead drives the nylon film and the FEP Teflon film to perform a cyclic motion of continuous contact and triboelectrification, separation to form a potential difference, subsequently create electrostatic induction, then re-contact and triboelectrification, and re-separation to generate a potential difference and subsequently create electrostatic induction. The two films contact and triboelectrify, accumulate static charges. When the external force is removed, the first friction layer automatically resets under the action of the curved spring arms and the twisting springs to separate from the second friction layer, thereby forming a potential difference and triggering an electrostatic induction effect. The first back electrode and the second back electrode periodically induce alternating charges and output alternating current, which is fed to the full-bridge rectifier module and converted into microampere-level weak direct current after rectification. All exposed conductive and electrified parts are wrapped with PI/PET insulating film materials to achieve full insulation protection. The rectification and energy storage assembly adopts a flexible encapsulating structure, with multiple layers of PET/PI insulating film cladding on the exterior and the edges thereof subject to reinforcement treatment, thereby providing capabilities of bending resistance, compression resistance and wear resistance.

The independent friction medium layers include a first friction layer formed of a polymer insulating film and a second friction layer formed of a polymer insulating film, and these two layers constitute a paired structure for triboelectrification. The independent friction medium layers form a friction pair composed of a nylon film and an FEP Teflon film, where the first friction layer is the nylon film and the second friction layer is the FEP Teflon film. Alternatively, the first friction layer is a PTFE polytetrafluoroethylene film, the second friction layer is an aluminum foil or a copper foil, and the distance between the two layers ranges from 0.01 mm to 50 mm.

The single suspended triboelectric nanogenerating massage bead of the present invention adopts one set of triboelectric nanogenerator (TENG) units. The triboelectric nanogenerator unit forms a friction power generation pair by using nylon film and FEP film. The diameter of each friction film is 10 mm, the thickness of the nylon film is 0.15 mm, the thickness of the FEP film is 0.10 mm, and the effective power generation area of the friction film is 0.78 cm².

During operation, the triboelectric nanogenerator unit outputs an instantaneous pulsed charge transfer current, its electrical safety performance is verified in accordance with GB/T 13870.1-2022 [Effects of current on human beings and livestock]—Part 1: General aspects and GB/T 3805-2008 [Extra-low voltage (ELV) limit values]. Under conventional service conditions of light touch and pressing, the peak output current of the power generation unit is at the microampere level. The perception current threshold range of human plantar skin is 0.2 μ A~1 μ A, and the current value perceivable by the human body is not less than 0.5 μ A.

Further, the present invention may be provided with four sets of mutually independent triboelectric nanogenerator units in a combined arrangement, and one independent friction power generation unit composed of a nylon film and an FEP film is correspondingly arranged inside each single massage bead. The four sets of triboelectric nanogenerator units are electrically connected in parallel with each other and jointly connected to the same rectification and energy storage assembly. Electric energy generated by each power generation unit is merged together, and then outputs microampere-level pulsed direct current sequentially through a rectifying energy storage capacitor and a current-limiting resistor.

The output of the triboelectric nanogenerator unit of the present invention is a low-frequency instantaneous pulsed current, rather than a continuous alternating current. The greater the pressure and the faster the contact-separation speed, the higher the amplitude of the output current and the more obvious the human body perception effect. The overall output current falls within a safe range that is perceptible to the human body without electric shock hazard or physiological damage, and meets the electrical safety requirements for wearable plantar massage products.

The rectification and energy storage assembly includes a full-bridge rectifier module and an energy storage capacitor. The full-bridge rectifier module converts alternating current into microampere-level weak direct current. The energy storage capacitor is connected in parallel to the DC output terminal of the full-bridge rectifier module, and cooperates with the current-limiting resistor to output stable and mild electric pulses for safe action on the skin at human acupoints. Polarities between the output terminals and the working electrodes (i.e., acupoint electrode contacts A and B) are matched to realize energy storage under voltage regulation status and ensure continuous and stable electric pulses. The spacing between the acupoint electrode contacts A and B is adapted to the massage structure, the triboelectric nanogenerator assembly and the current-limiting resistor. The acupoint electrode contacts A and B extend to the top surface of the massage structure through flexible wires passing through the connecting member and the massage structure. The rectifier bridge energy storage assembly and the current-limiting resistor are integrated on a compact flexible printed circuit board, which is fixedly and insulatively mounted above the connecting lines of the torsion extension arms, so as not to interfere with the downward pressing and rotational movement stroke of the massage beads. The positive terminal of the acupoint electrode contact A is connected to the positive pole of the energy storage capacitor, and the other end thereof extends to the top surface of the massage structure via a flexible wire passing through inner holes of the connecting member and the massage bead or grooves formed on the arc surface of the massage structure. The negative terminal of the acupoint electrode contact B is connected to the negative pole of the energy storage capacitor, and the other end thereof extends to the top surface of the massage structure via a flexible wire passing through inner holes of the connecting member and the massage bead or grooves formed on the arc surface of the massage structure.

The working electrodes are made of medical-grade conductive silicone, and are embedded in the top surface of the massage structure as acupoint electrode contacts for directly adhering to human skin. The positive and negative poles of the working electrodes are electrically connected in one-to-one correspondence with the positive and negative poles of the energy storage capacitor via flexible wires and current-limiting resistors, to output mild electrical pulse stimulation pulses. The nylon film back electrode and the FEP Teflon film back electrode (or the first back electrode and the second back electrode), the rectification and energy storage assembly, the current-limiting resistor and the working electrodes are electrically connected through flexible conductive conductors. All electrical connection points are fixed by plugging or welding and subjected to insulating and sealing treatment.

Multiple independent friction medium layer units can be connected in series, in parallel, or in a series-parallel hybrid connection to boost electric output and adapt to different massage intensities.

As shown in these Figures, the AC1 terminal of the rectifier bridge is connected to the back electrode of the nylon film, and the AC2 terminal thereof is connected to the back electrode of the FEP Teflon film. The positive pole of the rectifier bridge is connected to the positive pole of the energy storage capacitor, and the negative pole of the rectifier bridge is connected to the negative pole of the energy storage capacitor. The rectifier bridge adopts a full-bridge rectification structure, which may be composed of discrete diodes or implemented as an integrated rectifier bridge device. The energy storage capacitor is selected from tantalum capacitors or ceramic capacitors. The polarity at the output end of the energy storage capacitor matches the polarity of the working electrodes, and the withstand voltage is adapted to the output voltage of the triboelectric nanogenerator. Each of the back electrodes of the nylon film and the FEP Teflon film is made of aluminum foil or copper foil. In specific implementation, stress buffering treatment is applied to the lead-out parts of back electrode wires, the connection positions of torsion extension arms, and bending sections of flexible conductive connectors, so as to prevent wire fracture caused by long-term repeated bending. The surface of each module is treated with waterproof and sweat-proof coating to prevent internal short circuits induced by intrusion of sweat and moisture, enabling the device to stably adapt to the humid and dusty environment of human foot sole.

During operation, the working process is performed in the following steps: continuous external press acts on the massage bead→the two films come into contact to generate triboelectrification→external force is removed and the springs reset→the two films separate→continuous circulation of contact electrification and separation between the two films→a potential difference is formed between the friction layers to generate periodic electrostatic induction effects→the back electrodes continuously induce alternating charges and output alternating current→the current is converted into microampere-level direct current by the full-bridge rectifier module→the energy storage capacitor realizes voltage stabilization→the working electrodes output direct current with electrical pulses, thereby realizing composite massage combining mechanical massage and electrical pulse stimulation pulse massage synchronously.

It should be noted that the vertical arrangement positions of the nylon film and the FEP Teflon film in these Figures may be interchanged without affecting the electrification effect. The only difference lies in the phase reversal of alternating current. After rectification, the direct current output remains stable, which improves assembly flexibility.

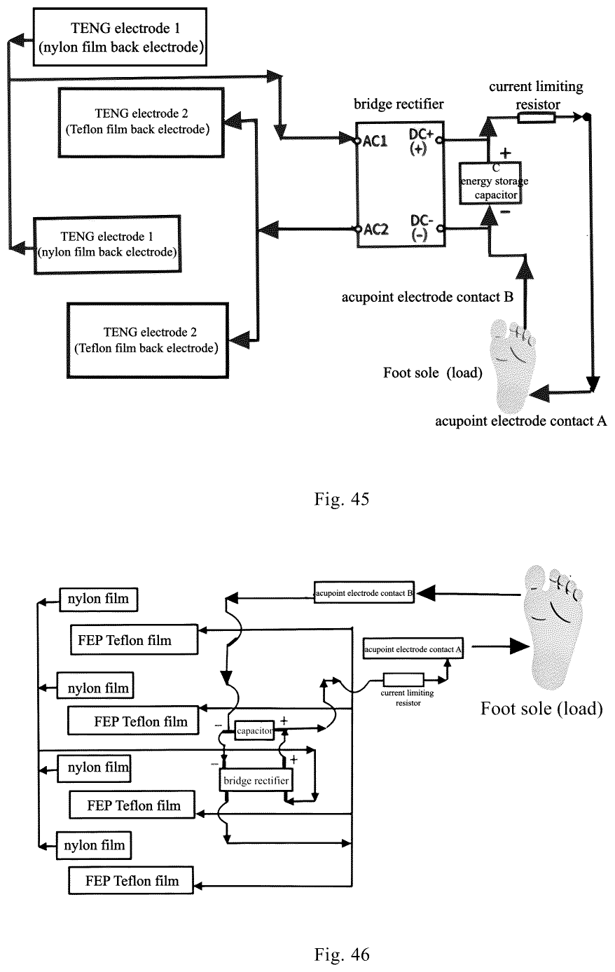

FIG. 45 is a circuit diagram of two triboelectric nanogenerator (TENG) units according to supplementary solution 2 of the present continuation application. As an additional embodiment of supplementary solution 2, two independent TENG units are adopted in FIG. 45 to supply current to the AC1 terminal and the AC2 terminal of the rectifier bridge respectively.

FIG. 46 is a parallel layout circuit diagram of four independent triboelectric nanogenerator (TENG) units according to supplementary solution 2 of the present continuation application. As another additional embodiment of supplementary solution 2, four sets of independent friction medium layers are connected in parallel to significantly increase electric output and meet the demand for high-intensity electric pulse massage. The quantity of independent friction medium units can be freely configured according to actual massage intensity requirements.

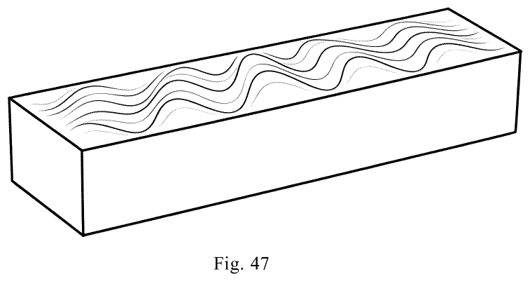

FIG. 47 is a structural diagram of an FEP Teflon film or a nylon film according to supplementary solution 2 of the present continuation application. As illustrated, the FEP Teflon film or the nylon film is provided with a wavy surface.

The supplementary solution 2 of the present continuation application overcomes the defects of existing massage beads, such as power supply dependency, poor comfort, low power generation efficiency and complex structure, and provides a suspended triboelectric nanogenerator massage bead. This suspended triboelectric nanogenerator massage bead realizes self-power supply, suspension buffering, and combined massage with mechanical and electrical pulse stimulation pulses, which saves time and labor, optimizes the massage experience, and improves convenience and user experience. Its beneficial effects are as follows:
1. complete self-power supply: electric energy is generated by mechanical energy from human applied pressure, no battery, charging or external power supply is required, featuring environmental friendliness and convenient use.
2. enhanced comfort via suspension buffering: twisting springs provide flexible buffering to avoid rigid impact, the curved surface combined with multiple protruding points fits closely to human skin and acupoints.
3. stable and efficient power generation: The standard nylon/FEP friction pair strongly electrifies, stable output is achieved after rectification and voltage regulation, and multi-unit expansion can be realized to meet personalized massage demands under different powers.
4. simple structure and easy mass production: the product features highly integrated components, compact size and flexible assembly, which is suitable for mass production and miniaturized manufacturing.
5. high safety and wide applicability: adopting medical-grade materials with no liquid leakage risk, it can be applied to multiple body parts including the neck, waist, back and limbs, and integrates mechanical massage and electric pulse massage functions.

What is claimed is:

1. A combined massage structure comprising massage beads, spring body insulating holders and massage hole seats, wherein each of the massage beads includes a massage structure, a connecting member and a spring body, the massage hole seats are disposed on an massage base plate, the spring body insulating holders are arranged inside the massage hole seats, a twisting spring at one end of the spring body is snap fitted in the spring body insulating holder, and the other end thereof is connected with a straight spring arm cavity formed on the connecting member with a clearance therebetween, the massage structure is fixedly connected to an end of the connecting member opposite to the spring body, and the massage beads protrude above the massage base plate.

2. The combined massage structure according to claim 1, wherein the spring body includes a pair of upper straight spring arms, one end of the pair of upper straight spring arms is suspended, and the other end thereof is bent and extended downward through a pair of curved spring arms to connect with a pair of twisting springs, and an extension arm is formed between the twisting springs.

3. The combined massage structure according to claim 2, wherein the top-view outline of the extension arm is Z-shaped or “-” shaped, and the extension arm is fixedly connected, the connection mode and connection structure thereof are not limited by the bottom outline shape of the extension arm.

4. The combined massage structure according to claim 3, wherein the spring body with Z-shaped extension arm and the spring body with “-” shaped extension arm are disposed to overlap individually or in combination at an angle, preferably perpendicularly, the spring body with Z-shaped extension arm and the spring body with “-” shaped extension arm are individually formed or integrally formed, or the Z-shaped and “-” shaped extension arms of the spring body are connected together by welding.

5. The combined massage structure according to claim 1, wherein the connecting member and the massage structure are arranged in one-to-one correspondence, the surface of the massage structure can be adapted to more than one massage contact point, the connecting member is provided with one pair, two pairs, single or double straight spring arm cavities, the straight spring arm cavities are configured to accommodate the straight spring arms of the spring body, the straight spring arms fit with the straight spring arm cavities with a clearance therebetween, and the straight spring arms can rotate circumferentially relative to the straight spring arm cavities, the straight spring arm cavities can also be inclined to fit the straight spring arms.

6. The combined massage structure according to claim 5, wherein the one pair or two pairs of straight spring arm cavities are configured to accommodate clockwise straight spring arms or counterclockwise straight spring arms respectively, the connecting member is provided with a plurality of limiting blocks extending downward, the limiting blocks are configured to limit the curved spring arms to ensure that the curved spring arms perform rotational movement within a limited area during the pressing down of the massage structure and the twisting of the spring body, an extension spring is disposed on the curved spring arms to increase the rotation span, and the extension springs are not limited by the outline shape.

7. The combined massage structure according to claim 5, wherein the connecting member is further provided with a plurality of ramps at positions adjacent to the limiting blocks, the ramps are configured to push the curved spring arms outward to prevent wear between the curved spring arms and the twisting springs, the connecting member cooperates with the massage structure to enclose the straight spring arms, the curved spring arms and the twisting springs in a space defined by the connecting member or the massage structure and the massage hole seats.

8. The combined massage structure according to claim 1, wherein the spring body insulating holder is provided with a notch on one side, the notch can temporarily reduce the diameter of the spring body insulating holder for facilitating to arrange inside the massage hole seat, the shape of the interfacing portion between the spring body insulating holder and the inner side of the massage hole seat may be regular shapes such as circle and square, or mutually mated concave-convex engagement structures, or a combination of regular shapes and concave-convex structures, the outer contour shape of the massage hole seat is circular, hexagonal, or a mixed shape of arcs and polygons, and the overall massage hole seat adopts a combined structure of cylinder, polygonal cylinder, or mixed cylinder with arcs and polygons.

9. The combined massage structure according to claim 1, wherein the spring body insulating holder is made of insulating materials such as PEEK and POM, the massage hole seats are assembled and fixed on the base plate by means of gluing, tenon-and-mortise connection or other methods in a corresponding arrangement and combination manner, or the massage hole seats are integrally formed with the base plate, the massage hole seats and the matched massage beads can be inclined arbitrarily as a whole to adapt to the curved surface of the foot sole, and the thicknesses of the massage hole seats and the base plate can be adjusted as required.

10. A suspended triboelectric nanogenerating massage bead comprising a combined massage structure, a triboelectric nanogeneration assembly, a rectification energy storage assembly, current-limiting resistors and working electrodes, wherein the combined massage structure includes massage bead, spring body insulating holder and massage hole seat, the massage bead comprises a massage structure, a connecting member and a spring body, a twisting spring at one end of the spring body is snap fitted in the spring body insulating holder, and straight spring arm at the other end thereof is connected with straight spring arm cavity on the connecting member with a clearance therebetween, the massage structure is fixedly connected to one end of the connecting member opposite to the spring body, when the external pressure is applied to the massage structure and a dynamic balance between the external pressure and the elastic force of the spring body is reached, suspended massage can be realized, the triboelectric nanogeneration assembly includes an independent friction medium layers and back electrodes, the independent friction medium layers form a friction pair composed of a nylon film and an FEP Teflon film, the nylon film is fixed inside the massage bead and connected to the connecting member, and the FEP Teflon film is disposed opposite to the nylon film, the back electrodes include a nylon film back electrode and an FEP Teflon film back electrode, which are respectively arranged on the sides of the two films away from the friction pair, the rectification energy storage assembly includes a full-bridge rectifier module and an energy storage capacitor, the input terminal of the full-bridge rectifier module is electrically connected to the back electrodes, and the positive and negative poles of DC output terminal of the full-bridge rectifier module are electrically connected in parallel with the positive and negative poles of the energy storage capacitor, the positive and negative poles of the energy storage capacitor are electrically connected in one-to-one correspondence with the positive and negative poles of the working electrodes through the current-limiting resistors, and the working electrodes are arranged on the top surface of the massage structure, when the external pressure on the massage structure and the elastic force of the spring body alternate between the dynamic balance condition and dynamic imbalance condition and a triboelectric nanogeneration state is established, suspended friction electrical pulse stimulation massage is realized.

11. The suspended triboelectric nanogenerating massage bead according to claim 10, wherein the suspended triboelectric nanogenerating massage bead comprises independent triboelectric nanogeneration units, namely independent TENG units, the independent TENG unit comprises a first friction layer and a corresponding first back electrode, as well as a second friction layer and a corresponding second back electrode, both the first friction layer and the second friction layer are made of insulating friction medium materials, which are prepared from any one or more of PTFE, PVDF, PDMS, PET, PI and nylon, the first back electrode and the second back electrode are adapted to flexible conductive electrodes, the first back electrode is attached to the back side of the first friction layer, and the second back electrode is attached to the back side of the second friction layer, the first friction layer and the second friction layer are arranged opposite to each other at intervals to form a friction power generation pair, and their arrangement positions are mutually interchangeable.

12. The suspended triboelectric nanogenerating massage bead according to claim 10, wherein the full-bridge rectifier module is provided with two AC input terminals, one DC positive output terminal and one DC negative output terminal, the two AC input terminals of the full-bridge rectifier module are electrically connected to the first back electrode and the second back electrode respectively, the DC positive output terminal and the DC negative output terminal of the full-bridge rectifier module are electrically connected to the positive pole and the negative pole of the energy storage capacitor in one-to-one correspondence, the full-bridge rectifier module is configured to rectify the output alternating current into unidirectional microampere-level weak direct current, the energy storage capacitor is configured to store the rectified pulsating DC electric energy, smooth, stabilize and filter the electric energy, and cooperate with the current-limiting resistor to continuously output stable and mild microampere-level electric pulse direct current to the working electrodes, and is connected in parallel between the two DC output terminals of the full-bridge rectifier module, a plurality of the rectification energy storage assemblies can be electrically connected in series, in parallel or in a series-parallel hybrid manner to meet different output requirements of voltage or current.

13. The suspended triboelectric nanogenerating massage bead according to claim 11, wherein the independent TENG unit includes a first friction layer and a second friction layer, both the first friction layer and the second friction layer are insulating polymer films with triboelectric characteristics, and are correspondingly provided with a first back electrode and a second back electrode respectively, the first back electrode and the second back electrode are flexible conductive electrodes, the triboelectric nanogeneration assembly further comprises current-limiting resistors, the current-limiting resistors can be arranged between the DC positive output terminal of the full-bridge rectifier module and an external load in a series, parallel or series-parallel hybrid connection manner, the independent TENG unit is characterized in that, on the opposite contact surfaces of the first friction layer and the second friction layer, at least one surface is provided with protruded structures or wave structures, regular or irregular hybrid protruded structures, the first friction layer adopts a nylon film and the second friction layer adopts an FEP film; or the first friction layer adopts a PTFE film and the second friction layer adopts an aluminum foil or a copper foil, and the two groups of materials are paired respectively to form the friction power generation pair.

14. The suspended triboelectric nanogenerating massage bead according to claim 10, wherein the working electrodes include positive acupoint electrode contacts and negative acupoint electrode contacts, one end of each positive acupoint electrode contact is connected to the positive pole of the energy storage capacitor, and the other end thereof is connected with flexible wires which pass through inner openings of the connecting member and the massage structure or extend to the top surface of the massage structure via grooves formed on the arc surface of the massage structure, to contact with the skin of the human foot sole, one end of each negative acupoint electrode contact is connected to the negative pole of the energy storage capacitor, and the other end thereof is connected with flexible wires which pass through inner openings of the connecting member and the massage structure or extend to the top surface of the massage structure via grooves formed on the arc surface of the massage structure, to contact with the skin of the human foot sole, the first friction layer descends under external pressing force and rotates under the action of the curved spring arms to contact with the second friction layer to generate triboelectrification, and static charges accumulate on the friction interface, after the external force is removed, the first friction layer is automatically reset under the action of the curved spring arms and the twisting springs, separated from the second friction layer to form a potential difference, thereby generating an electrostatic induction effect, under repeated external force, the first friction layer continuously descends, rotates and contacts the second friction layer then separates from the second friction layer and resets, and static charges accumulate on the friction interface continuously, the separation process continuously triggers electrostatic induction, so that the first back electrode and the second back electrode periodically induce alternating charges to output alternating current, the alternating current is sent to the full-bridge rectifier module and converted into microampere-level weak direct current electric energy after rectification, the microampere-level weak DC electric energy sequentially passes through the positive pole of the energy storage capacitor and the current-limiting resistor, passes through the connecting member and the massage structure along the flexible wire, and is transmitted to the positive acupoint electrode contacts on the top surface of the massage structure, to realize microampere-level weak electrical pulse stimulation on the foot sole, the microampere-level weak direct current electric energy is further conducted to the negative acupoint electrode contacts on the top surface of the massage structure through the skin of the foot sole of human, and flows back to the negative pole of the energy storage capacitor through the flexible wires to form a complete current loop, the space between the positive and negative acupoint electrode contacts is matched with the massage structure, the triboelectric nanogeneration assembly and the current-limiting resistors, both the positive acupoint electrode contacts and the negative acupoint electrode contacts are made of flexible conductive biocompatible electrode materials, which are selected from any one of conductive silica gel, conductive silver paste, flexible conductive fabrics and silver-plated copper conductive films.

15. The suspended triboelectric nanogenerating massage bead according to claim 10, wherein the rectifier bridge energy storage assembly and current-limiting resistor are integrated on a small scale flexible printed circuit board, which is fixedly and insulatively mounted at connecting line position of twisting extension arm, so as not to interfere with the downward pressing and rotational movement stroke of the massage bead, all exposed points of electrical connections are insulated by encapsulation.

16. The suspended triboelectric nanogenerating massage bead according to claim 10, wherein parts of the electrical connections adopt flexible conductive conductors to achieve electrical connection; the points of the electrical connection are fixedly connected by plugging or welding and undergo insulated sealing treatment, all exposed conductive parts and live structures are insulated and covered with PI/PET insulating films to form an overall fully insulated protective structure, said rectifier energy storage assembly and the corresponding current-limiting resistor can adopt a flexible encapsulation structure, the outer surface of the flexible encapsulation structure is encapsulated by PI/PET insulating films and reinforced at the edges thereof.

17. The suspended triboelectric nanogenerating massage bead according to claim 11, wherein the independent TENG unit includes at least one set of friction medium layer units, multiple sets of friction medium layer units may be electrically connected in series, in parallel, or in a series-parallel hybrid manner, the distance between the first friction layer and the second friction layer ranges from 0.01 mm to 50 mm.

18. A massage base plate for a massage shoe, characterized in that the massage base plate is a base component for bearing a massage assembly in the massage shoe, the massage base plate is provided with a special-shaped structure adapted to the physiological curved contour of a human foot, and protrusions are arranged at the position corresponding to the arch of the human foot, the bottom surface of the massage base plate can be configured as a smooth surface or a rough surface, or provided with a plurality of holes and/or grooves, the shape, quantity and arrangement mode of the holes and/or grooves can be set in any combined manner to mount massage hole seats of different specifications and shapes.
